(19) United States
(12) Patent Application Publication
(10) Pub. No.: US 2016/0332494 A1
(43) Pub. Date: Nov. 17, 2016

(54) A SURFACE VEHICLE

(71) Applicant: WAREHAM STEAMSHIP CORPORATION, Acton, MA (US)

(72) Inventor: Craig Brendan RUSSELL, Auckland (NZ)

(73) Assignee: WAREHAM STEAMSHIP CORPORATION, Acton, MA (US)

(21) Appl. No.: 15/106,406

(22) PCT Filed: Dec. 19, 2014
(86) PCT No.: PCT/IB2014/067103

§ 371 Date: Jun. 20, 2016

Related U.S. Application Data
(60) Provisional application No. 61/918,793, filed on Dec. 20, 2013.

(51) Int. Cl. B60F 3/00

(52) U.S. Cl. CPC B60F 3/0007; B60F 2301/04

(57) ABSTRACT

A ground engagement assembly to be located at the bow of an amphibious surface vehicle is described. It may have a strut assembly engaged or engageable to a hull of a marine vessel. The strut assembly has a primary arm that carries a wheel. The wheel is can move between a marine mode position and a land mode position where the wheel is able to locate on the ground to support at least part of the hull above the ground. A primary actuator extends to the primary arm to move the wheel between the ground mode position and the marine mode position. The strut assembly is configured and adapted to be retrofitable to a hull without the need for the hull to be modified to receive the struts assembly during its movement between the marine mode position and the land mode position.

### FIELD OF THE INVENTION

The invention relates to surface vehicles, and more particularly to amphibious vehicles surface vehicles and related assemblies and subassemblies.

### BACKGROUND

Amphibious vehicles for transport both on land and in the water are often equipped with a set of wheels for driving and steering the craft on land. The wheels can be moved from a deployed condition for use on land to a stowed condition for when the craft is to be driven on water.

The wheels must be attached to the hull of the craft in such a manner that they can support and drive or allow driving of the craft on land. It is convenient for the wheels to be controllable by the marine steering system of the craft. Therefore the wheel assembly may contain a number of components such as mountings, struts, hubs and tyres which move relative to each other and to the craft.

In the undeployed condition, the wheel assemblies may be drawn up and retained in a retracted position alongside of the hull/bow/stern, but will often protrude from the line of the hull to some extent and often quite significantly. The projecting wheel assemblies can make ingress and egress more difficult for passengers climbing over the sides of the craft, and may tend to bump or catch on objects in the water as the craft passes them by.

The wheel assembly components projecting from the hull can also result in reduced hydrodynamic performance of regions on the outside of the craft. This results in excessive drag on the craft and water spray upon the occupants of the craft. Such components may themselves suffer damage from constant exposure to and/or immersion in the water.

Where a water going craft is being retrofitted with wheels for amphibious use, the attachment of the wheels and their connection to an appropriate drive and steering system can require expensive and obtrusive alterations, especially to the hull area of the craft. The design of the wheel mountings and struts must be adapted according to the contours of the hull of the craft to be fitted, and this requires customised manufacture and fitting of such components.

Where the wheel and associated components are, when in the stowed condition, retained outside of the hull/bow/stern profile, the mechanisms required to move the wheels from the deployed to undeployed condition may still need to be housed inside of or partially inside of the hull/bow/stern. It can be the case that otherwise undesirable modifications to the hull/bow/stern must be made in order to permit the required range of movement of these mechanisms.

The wheel assembly desirably comprises at least some form of steering actuator and some form of actuator to move the wheel between its deployed and stowed conditions. While it is convenient to provide pneumatic or electrically driven cylinder type actuators, it can be difficult to position these to avoid clashes in their respective paths of motion without some degree of loss in the mechanical efficiency of the actuated system due to that positioning.

In some instances, for example when the craft is being towed on land by another vehicle, it may be desirable to disconnect the wheels of the amphibious craft from its marine steering (or otherwise disable the steering) so that it can follow freely behind the tow vehicle. In such instances it can be complex to disengage the wheel assembly components from the steering system, and can also be difficult to correctly reengage with the system so that the alignment of the wheel corresponds with the appropriate direction of the marine steering system.

Examples of vehicles are described in US2012/0108118, U.S. Pat. No. 7,520,239 and U.S. Pat. No. 7,874,259 to name a few.

Accordingly it is an object of the present invention to provide improvements in or relating to surface vehicles that may address at least one of the abovementioned desiderata and/or which may provide the public with a useful choice.

It is a further object of the present invention to provide a wheel assembly for an amphibious craft which overcomes or at least partially ameliorates some of the abovementioned disadvantages or which at least provides the public with a useful choice.

### BRIEF DESCRIPTION OF THE INVENTION

In a first aspect the present invention may be said to be a steerable ground engagement assembly for an amphibious surface vehicle comprising:

a strut assembly engaged or engageable to a hull of a marine vessel and comprising
a) a primary arm pivotally mounted at a proximal end relative said hull and having a distal end away from the hull,
b) a steering knuckle, carrying a ground engagement device capable of being presented by the strut assembly in (a) a marine mode position where the ground engagement device is supported above the waterline of the vessel and (b) a land mode position where the ground engagement device is able to locate on the ground to support at least part of the hull above the ground, said steering knuckle journalled from said primary arm toward its distal end to allow a rotation of the ground engagement device in a manner to control the direction of motion of the ground engagement device over the ground when in the land mode position,
c) a primary actuator operative between said hull and said primary arm, acting on the primary arm at or near its distal end to pivotally move said primary arm on an axis of rotation to thereby move the ground engagement device between the land mode position and the marine mode position.

Preferably the steering knuckle is journalled to said primary arm intermediate of the proximal end of the primary arm and where the primary actuator acts on the primary arm.

Preferably the ground engagement device is a wheel.

Preferably the steering knuckle is journalled to said primary arm only intermediate of the proximal end of the primary arm and where the primary actuator acts on the primary arm.

Preferably the primary actuator is a linear actuator that extends between the distal end of the primary arm and the hull.

Preferably the linear actuator is pivotally engaged to the primary arm at the distal end of the primary arm and pivotally engaged relative the hull at a location away from the axis of rotation of the primary arm.

Preferably said steering knuckle is journalled to said primary arm by bearings.

Preferably there are two bearings spaced apart each other and along an axis of rotation of the steering knuckle relative the primary arm.

Preferably the bearings are located at the proximal more side of the primary arm to where the linear actuator acts on the primary arm.

Preferably the steering knuckle can swivel relative to the primary arm about an axis that is not parallel the axis of rotation of the primary arm relative to the hull.

Preferably when in the land mode position, the steering knuckle can swivel relative to the primary arm about an axis that is substantially vertical or not horizontal.

Preferably the steering knuckle can swivel relative to the primary arm about an axis that is parallel a notional vertical plane passing through the centreline of the vessel.

Preferably the steering knuckle has a hub at which the ground engagement device is supported, the steering knuckle presents the hub relative the primary arm so that the distal end of the primary arm is adjacent the ground engagement device.

Preferably the steering knuckle presents the hub a position relative the primary arm so that the distal end of the primary arm is immediately adjacent the ground engagement device so that the linear actuator acts on the primary arm as close as possible to the ground engagement device.

Preferably the distal end of the primary arm is located intermediate of the ground engagement device and the axis of rotation of the primary arm.

Preferably the primary actuator holds said strut assembly in the land mode position.

Preferably the strut assembly has an over centre geometry of a configuration able to be held in said land mode position under the weight of the vehicle.

Preferably the strut assembly can be mechanically locked in the land mode position.

Preferably rein axis of rotation of the primary arm is perpendicular a notional vertical plane passing through the centreline of the vessel.

Preferably the primary actuator is a linear actuator.

Preferably the primary actuator is an electric, pneumatic or hydraulic actuator.

Preferably the linear actuator is pivotally mounted adjacent the axis of rotation of the primary arm to be able to rotate on an axis of rotation (herein after “actuator axis”) that is parallel the axis of rotation of the primary arm.

Preferably the actuator axis is further from where the primary actuator acts on said primary arm at its distal end then said axis of rotation of said primary arm.

Preferably the distance between the actuator axis and the axis of rotation of the primary arm is less than the distance between the axis of rotation of the primary arm and the location at where the linear actuator acts on the primary arm at the distal end.

Preferably the distance between the actuator axis and the axis of rotation of the primary arm is less than 50% the distance between the axis of rotation of the primary arm and the location at where the linear actuator acts on the primary arm at the distal end.

Preferably the distance between the actuator axis and the axis of rotation of the primary arm is less than 20% the distance between the axis of rotation of the primary arm and the location at where the linear actuator acts on the primary arm at the distal end.

Preferably the distance between the actuator axis and the axis of rotation of the primary arm is less than 10% the distance between the axis of rotation of the primary arm and the location at where the linear actuator acts on the primary arm at the distal end.

Preferably in use, the axis of rotation is below the actuator axis.

Preferably in use, the axis of rotation is proximate more the stern of the vessel than the actuator axis.

Preferably the primary arm is bifurcated to provide a slot in which at least part of said primary actuator is located.

Preferably the primary arm is recessed to provide a cavity in which at least part of said primary actuator is located.

Preferably the linear actuator is a hydraulic ram that comprises a cylinder and a piston rod.

Preferably one of the piston rod and cylinder is pivotally connected to the primary arm at or near its distal end.

Preferably the other of the piston rod and cylinder is pivotally mounted relative the hull.

Preferably the other of the piston rod and cylinder is (preferably pivotally) connected to the hull.

Preferably the other of the piston rod and cylinder is connected with the hull at a mount that is attached to the hull.

Preferably the strut assembly is able to engage to a/the mount.

Preferably the primary arm is pivotally attached to the mount.

Preferably the mount is of a kind as is herein described.

Preferably the primary arm and mount and ram form a triangular force relationship therebetween.

Preferably the steering knuckle is able to swivel relative said primary arm by virtue of its journalled relationship.

Preferably the steering knuckle is able to swivel in a driven manner.

Preferably the steering knuckle is able to swivel is an idle manner.

Preferably the steering knuckle can be coupled with a draw bar to pull the vehicle when in the ground mode.

Preferably the steering knuckle is able to become idle for swivelling relative the primary arm for the purposes of a pulling of the vehicle by way of a draw bar able to be coupled with a draw bar.

Preferably the marine vessel is one selected from a monohull, multihull, pontoon, barge and floating dock.

Preferably the ground engagement member is able to be retrofitted to the hull of a marine vessel.

In a second aspect the present invention may be said to be a marine vessel having a hull defining a bow and a stern, wherein at the bow there is secured the assembly as herein described.

Preferably the assembly as herein described is mounted in a manner to present the primary actuator in the land mode position, forward more of the primary arm.

Preferably the assembly presents the primary actuator in the land mode position, forward of a notional line between the actuation location of the primary actuator on the arm and the axis of rotation of the primary arm.

Preferably the assembly presents the primary actuator, when in the marine mode position, above of a notional line between the actuation location of the primary actuator on the arm and where the arm is pivotally mounted to the hull of the vessel.

Preferably the assembly presents the actuator in the marine mode position, above the primary arm.

Preferably the primary arm pivotally moves relative said vessel between a more vertical orientation when in the land mode position and a more horizontal orientation when in the marine mode position.

Preferably the primary actuator pivotally moves relative said vessel between a more vertical orientation when in the land mode position and a more horizontal orientation when in the marine mode position.

Preferably the axis of rotation of the primary arm is below where the primary actuator is pivotally secured relative the hull.

Preferably the pivot axis of the primary arm is more proximate the stern of the hull to where the primary actuator is secured relative the hull.

In a further aspect the present invention may be said to be a steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by bearings to allow the steering knuckle to turn the wheel relative the primary arm,
3) a hydraulic ram to act between the hull and the primary arm to raise and/or lower the primary arm the steering knuckle and the wheel relative the hull, the ram acting on the primary arm at a location that is proximate more the wheel than where the bearings are located.

In yet a further aspect the present invention may be said to be a steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by at least one bearing to allow the steering knuckle to turn the wheel relative the primary arm,
3) an actuator to act between the hull and the primary arm to raise and/or lower the primary arm the steering knuckle and the wheel relative the hull, the actuator acting on the primary arm at a location that is proximate more the wheel than where the at least one bearing is located.

In still a further aspect the present invention may be said to be a steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by bearings to allow the steering knuckle to turn the wheel relative the primary arm to steer the vehicle when supported and moving on ground, in it the lowered position
3) an actuator to act between the hull and the primary arm to raise and/or lower the primary arm the steering knuckle and the wheel relative the hull, the actuator acting on the primary arm at a location juxtaposed the wheel.

In still a further aspect the present invention may be said to be a steerable ground engagement assembly of an amphibious surface vehicle comprising:
1) a primary arm pivotally coupled to a marine hull in a manner to be capable of being raised and lowered relative to said hull,
2) a wheel support to rotationally support a wheel, carried by said primary arm to be raised and lowered with said primary arm and
3) an actuator to act between the hull and the primary arm to raise and/or lower the primary arm the wheel support and the wheel relative the hull, the actuator acting on the primary arm at a location juxtaposed the wheel.

Also herein described is a steerable ground engagement assembly for an amphibious surface vehicle comprising:

a strut assembly engaged or engageable to a hull of a marine vessel and comprising
1) a primary arm pivotally mounted at a proximal end relative said hull,
2) a steering knuckle, carrying a ground engagement device (preferably a wheel) capable of being presented by the strut assembly in (a) a marine mode position where the ground engagement device is supported above the waterline of the vessel and (b) a land mode position where the ground engagement device is able to locate on the ground to support at least part of the hull above the ground, said steering knuckle journalled for rotation about a steering axis and from said primary arm to allow a rotation of the ground engagement device, in a manner to control the direction of motion of the ground engagement device over the ground when in the land mode position,
3) a double acting linear actuator operative between the primary arm and the steering knuckle in a manner to (a) transfer forces there between to cause the steering knuckle to rotate about the steering axis relative the primary arm and (b) prevent bending moment loading of the linear actuator.

Preferably the linear actuator is operative between the primary arm and the steering linkage in a manner to (a) transfer forces there between to cause the steering knuckle to rotate about the steering axis relative the primary arm and (b) prevent bending moment loading along the axis of operation of the linear actuator.

Preferably the linear actuator is a ram (preferably hydraulic or pneumatic ram) and includes a cylinder and a piston rod, the cylinder is coupled to one of the primary arm and the steering knuckle so that load transfer there between is vectored along the axis of operation of the ram and where the piston rods is coupled to the other of the primary arm and steering knuckle so that the load transfer there between is vectored along the axis of operation.

Preferably one of the cylinder and a piston rod is coupled to the steering knuckle in a symmetrical manner about the axis of operation.

Preferably one of the cylinder and a piston rod is coupled to the primary arm in a symmetrical manner about the axis of operation.

Preferably one of the cylinder and a piston rod is coupled to the steering knuckle in a symmetrical manner about the axis of operation and the other of the cylinder and a piston rod is coupled to the primary arm in a symmetrical manner about the axis of operation.

Preferably a coupling member is used intermediate of one of the piston rod and cylinder, the coupling able to pivot relative the ram and able to transmit forces between the ram and one of the steering knuckle and the primary arm in a manner symmetric about the axis of operation of the ram.

Preferably a primary actuator is provided to pivotally move said primary arm to move the ground engagement device between the ground mode position and the marine mode position.

Preferably the primary actuator is a ram to act on the primary arm at or near its distal end.

Preferably the steering knuckle is at least partially journalled to said primary arm intermediate of the proximal end of the primary arm and where the primary actuator acts on the primary arm.

Preferably the steering knuckle is completely journalled to said primary arm intermediate of the proximal end of the primary arm and where the primary actuator acts on the primary arm.

Preferably the ram extends between the distal end of the primary arm and the hull.

Preferably the ram is engaged to the primary arm at the distal end of the primary arm and with the hull at a location away from the pivotally mounted proximal end of the primary arm.

Preferably said steering knuckle is journalled to said primary arm by bearings.

Preferably there are two bearings spaced apart each other and along an axis of rotation of the steering knuckle relative the primary arm.

Preferably the bearings are located at the proximal more side of the primary arm to where the ram acts on the primary arm.

Preferably the steering knuckle can swivel relative to the primary arm about an axis that is not parallel the axis of rotation of the primary arm relative to the hull.

Preferably the steering knuckle can swivel relative to the primary arm about an axis that is not parallel the axis of rotation of the primary arm relative to the hull.

Preferably when in the land mode position, the steering knuckle can swivel relative to the primary arm about an axis that is substantially vertical or not horizontal.

the steering knuckle can swivel relative to the primary arm about an axis that is parallel a notional vertical plane passing through the centreline of the vessel.

Preferably the primary arm is pivotal relative the hull about a pivot axis that is perpendicular a notional vertical plane passing through the centreline.

Preferably the steering knuckle has a hub at which the ground engagement device is supported.

Preferably the steering knuckle presents the hub a position relative the primary arm so that the distal end of the primary arm is adjacent the ground engagement device.

Preferably the steering knuckle presents the hub a position relative the primary arm so that the distal end of the primary arm is immediately adjacent the ground engagement device so that the ram acts on the primary arm as close as possible to the ground engagement device.

Preferably the primary actuator holds said strut assembly in the land mode position.

Preferably the strut assembly has an over centre geometry of a configuration able to be held in said land mode position under the weight of the vehicle.

Preferably the strut assembly can be mechanically locked in the land mode position.

Preferably the ram of the primary actuator is a hydraulic ram.

Preferably the ram comprises a cylinder and a piston rod.

Preferably one of the piston rod and cylinder is (preferably pivotally) connected to the arm at or near its distal end.

Preferably the other of the piston rod and cylinder is (preferably pivotally) connected with the hull.

Preferably the other of the piston rod and cylinder is (preferably pivotally) connected to the hull.

Preferably the other of the piston rod and cylinder is (preferably pivotally) connected with the hull at a mount that is attached to the hull.

Preferably the strut assembly is able to engage to a/the mount.

Preferably the primary arm is attached to the mount.

Preferably the mount is of a kind as is herein described.

Preferably the primary arm and mount and ram form a triangular force relationship therebetween.

Preferably the steering knuckle is able to swivel relative said primary arm by virtue of its journalled relationship.

Preferably the steering knuckle is able to swivel in a driven manner yet be decoupled from the steering ram to be able to swivel is an idle manner.

Preferably the steering knuckle can be coupled with a draw bar to pull the vehicle when in the ground mode.

Preferably the steering knuckle is able to become idle for swivelling relative the primary arm for the purposes of a pulling of the vehicle by way of a draw bar able to be coupled with a draw bar.

Also herein described is an amphibious surface vehicle that includes a steerable ground engagement assembly as herein above described.

Preferably the amphibious surface vehicle comprises a hull.

Preferably the steerable ground engagement member is engaged to the hull at or near the bow.

Preferably there is only one steerable ground engagement member carried by the hull.

Preferably there are steerable two ground engagement members carried by the hull.

Preferably the marine vessel is one selected from a monohull, multihull, pontoon, barge and floating dock.

Preferably the ground engagement member is able to be retrofitted to the hull of a marine vessel.

Also herein described is a steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by at least one bearing to allow the steering knuckle to turn the wheel relative the primary arm,
3) a primary linear actuator to act between the hull and the primary arm to raise and/or lower the primary arm the steering knuckle and the wheel relative the hull, the primary linear actuator acting on the primary arm at a location that is proximate more the wheel than where the at least one bearing is located and
4) a steering linear actuator operative between the primary arm and the steering knuckle to steer the wheel in a controlled manner, the steering linear actuator, the steering knuckle and the primary arm configured and adapted to ensure that force transfer there between does not cause a bending moment in the steering linear actuator.

Also herein described is a steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm at least one bearing to allow the steering knuckle to turn the wheel relative the primary arm,
3) a primary linear actuator to act between the hull and the primary arm to raise and/or lower the primary arm the steering knuckle and the wheel relative the hull, the primary linear actuator acting on the primary arm at a location that is proximate more the wheel than where the at least one bearing is located, and
4) a steering linear actuator operative between the primary arm and the steering knuckle to steer the wheel in a controlled manner, the steering linear actuator, the steering knuckle and the primary arm configured and adapted to ensure that the force applied by the linear actuator results in an opposing force applied there to that is coaxial the force applied.

Also herein described is a steerable ground engagement assembly for an amphibious surface vehicle comprising:

a strut assembly engaged or engageable to a hull of a marine vessel and comprising
1) a primary arm pivotally mounted at a proximal end relative said hull,
2) a steering knuckle, carrying a ground engagement device (preferably a wheel) capable of being presented by the strut assembly in (a) a marine mode position where the ground engagement device is supported above the waterline of the vessel and (b) a land mode position where the ground engagement device is able to locate on the ground to support at least part of the hull above the ground, said steering knuckle journalled for rotation about a steering axis and from said primary arm to allow a rotation of the ground engagement device, in a manner to control the direction of motion of the ground engagement device over the ground when in the land mode position,
3) a linear actuator, (preferably a ram that is preferably double acting) having
   1. an operative mode wherein it is coupled to the primary arm and the steering knuckle in a manner to transfer forces there between to cause the steering knuckle to rotate about the steering axis relative the primary arm, and
   2. an idle mode where it is decoupled from one or both of the steering knuckle and primary arm to allow the steering knuckle to be turned in an idle manner.

Also herein described is an amphibious surface vehicle comprising a marine hull and a ground engagement assembly engaged to the hull, the ground engagement assembly comprising a strut assembly from which a ground engagement device is dependent to be moved thereby between a land mode position and a marine mode position and wherein in at least the land mode position, the ground engagement assembly presents a boarding step for use by a person to aid in boarding the vessel.

Preferably the boarding step is supported from the primary arm.

Preferably the boarding step is supported from the mount that secures the strut assembly to the vessel.

Preferably the boarding step is a series of steps spaced apart along the primary arm.

Also herein described is a multi-hulled amphibious surface vehicle having two adjacent pontoon, there being a ground engagement assembly secured to the hull intermediate of the two pontoons, the ground engagement assembly comprising a strut assembly from which a ground engagement device is dependent to be moved thereby between a land mode position and a marine mode position.

Preferably the ground engagement assembly is of a kind as herein before described.

Preferably the ground engagement assembly is secured to the hull above the waterline.

Preferably the ground engagement assembly when in the marine mode position is above the waterline.

Also herein described is an amphibious surface vehicle comprising a marine hull having two adjacent bows sections about the vehicle centre line separated by a gap there between, there being a ground engagement assembly secured to the hull intermediate of the two bow sections, the ground engagement assembly comprising a strut assembly from which a ground engagement device is dependent to be moved thereby between a land mode position and a marine mode position.

Preferably the ground engagement assembly is of a kind as herein before described.

Preferably the ground engagement assembly is secured to the hull above the waterline.

Preferably the ground engagement assembly when in the marine mode position is above the waterline and located entirely in or above the gap between the two bow sections.

Also herein described is a ground engagement assembly of or for a amphibious surface vehicle having a marine hull, secured or able to be secured to the marine hull at the bow, the ground engagement assembly comprising two strut assemblies, one on each side of the centreline of the marine vessel, each strut assembly comprising:
1) a primary arm pivotally mounted at a proximal end relative said hull,
2) a steering knuckle, carrying a ground engagement device (preferably a wheel) capable of being presented by the strut assembly in (a) a marine mode position where the ground engagement device is supported above the waterline of the vessel and (b) a land mode position where the ground engagement device is able to locate on the ground to support at least part of the hull above the ground, said steering knuckle journalled for rotation about a steering axis and from said primary arm to allow a rotation of the ground engagement device, in a manner to control the direction of motion of the ground engagement device over the ground when in the land mode position.

Preferably each strut assembly is engaged to the hull in a pivotal manner.

Preferably each strut assembly can be moved from the ground mode position to the marine mode position by motion towards the stern and upwards.

Preferably each strut can move independently of the other.

Preferably each strut is engaged to the hull via a mount.

Preferably the mount is secured with the hull.

Preferably a single mount is provided for both struts.

Preferably the mount is an arm that has a mounting member to secure to the hull and is presented to locate a strut as each distal end of the arm.

Preferably each strut is mounted by the arm to be able to move in a rotational manner relative the hull.

Preferably the arm is pivotally mounted to the hull.

Preferably the arm is non pivotally mounted to the hull and the struts are pivotally mounted to the arm.

Preferably the arm hold the struts in a manner to be able to move to the marine mode position in a location juxtaposed the hull of the vessel.

Preferably the struts in the marine mode position are located juxtaposed the hull of the vessel.

Preferably the rotational position of the struts in the land mode is able to vary in response to changing terrain that is encountered.

Also herein described is a ground engagement assembly of or for an amphibious surface vehicle comprising:

a strut assembly engaged or engageable at the bow of and to a hull of a marine vessel,

a ground engagement device (preferably a wheel) carried by and capable of being presented by the strut assembly in (a) a marine mode position where the ground engagement device is supported above the waterline of the vessel and (b) a land mode position where the ground engagement device is able to locate on the ground to support at least part of the hull above the ground,

a cover for the ground engagement device, movably secured to the strut assembly in a manner to move between a first position when the ground engagement assembly is in the land mode position and a second position when the ground engagement assembly is in the marine mode position, the second position presenting the cover in a location adjacent at least part of the ground engagement device to deflect incident water (eg from a wave of bow spray of the like) that may be encountered when the vessel is in the water (preferably when underway), about and/or way from at least part of the ground engagement device.

Preferably when in the second position the cover is located across the forward most part of the ground engagement device.

Preferably when in the second position, the cover is located across the forward facing portions of the ground engagement device.

Preferably in the first position, the cover acts as a mudguard.

Preferably in the first position and second position, the cover remains equally juxtaposed the ground engagement device.

Preferably the ground engagement device is a wheel and the cover moves along an arc that is co-centric the rotational axis of the wheel.

Preferably the cover is a mud guard.

Preferably the cover is able to be moved between first and second positions by an actuator.

Preferably the actuator is a motor.

Preferably the actuator is a ram.

Preferably the actuator is rotary motor (eg electric, or hydraulic).

Preferably the motor can turn a pulley that is engaged with a cable that is connected to the cover to put the cover between first and second positions.

Preferably the strut assembly is engaged or engageable at the bow of and to a hull of a marine vessel.

Preferably strut assembly comprises a primary arm pivotally mounted at a proximal end relative said hull.

Preferably the ground engagement assembly is a steerable ground engagement assembly comprising a strut assembly that comprises:
1) a primary arm pivotally mounted at a proximal end relative said hull,
2) a steering knuckle, carrying said ground engagement device.

Preferably said steering knuckle is journalled from said primary arm toward its distal end away from the hull to allow a rotation of the ground engagement device in a manner to control the direction of motion of the ground engagement device over the ground when in the land mode position,

Preferably a primary actuator is provided to pivotally move said primary arm to move the ground engagement device between the ground mode position and the marine mode position.

Preferably the primary actuator is a ram to act on the primary arm at or near its distal end.

Preferably the steering knuckle is at least partially journalled to said primary arm intermediate of the proximal end of the primary arm and where the primary actuator acts on the primary arm.

Preferably the cover is moveably engaged to the steering knuckle.

Also herein described is an amphibious ground vehicle that comprises a marine hull and the ground engagement assembly as herein above ad/or elsewhere described.

Preferably the hull presents the ground engagement assembly at the bow of the marine hull.

Preferably the ground engagement assembly is positioned in the marine mode with its ground engagement device above the waterline of the hull.

Preferably the ground engagement assembly is positioned in the marine mode above the waterline of the hull.

Preferably the ground engagement assembly is positioned in the land mode with its ground engagement device below the waterline of the hull.

Preferably the ground engagement assembly is positioned in the land mode with its ground engagement device below the hull.

Preferably the cover will deflect incident water spray about at least part of the ground engagement device and onto the hull.

Also herein described is a bow wheel assembly for an amphibious surface vehicle that can facilitate the moving of the vehicle over land yet be moved to a condition substantially above the water line of the vehicle to reduce interference of vehicle movement in water, the bow wheel assembly comprising a wheel and a cover for the wheel, the cover for the wheel movably supported relative to the wheel to move to and away from a position relative the wheel where the cover improves aerodynamic and hydrodynamic performance to the wheel when the vehicle is making headway in water.

Also herein described is a mount for retrofitting a strut assembly to a marine hull of an amphibious surface vehicle, the strut assembly carrying a ground engagement device which facilitates the moving of the vehicle over land, the mount comprising:

two mounting members by which the mount can be secured to the hull, the two mounting members each presenting hull contact surfaces to locate stably (preferably flush) against (whether directly or indirectly, eg with an intermediate spacer between) the hull and that are moveably connected to each other so as to be able to accommodate variation in the surface of the hull at where the mount is to be secured, the mounting members when so secured presenting a bracket to or by which the strut assembly is/can be supported.

Preferably the two mounting members are secured to the hull by way of mechanical fastening or welding.

Preferably the mechanical fastening is a threaded fastening (eg by way of nuts and/or associated bolts).

Preferably the two mounting members are able to move relative each other to each be able to locate flush against the hull one on other side of the bow centreline of the hull.

Preferably the bracket allows a strut assembly to be supported in a manner to pivot relative to the hull.

Preferably the pivot is about one axis of rotation only.

Preferably the two mounting members are mounting plates.

Preferably the two mounting plates can each pivot about a respective axis.

Preferably the axes of pivot of the mounting plates are parallel of at an acute angle to each other.

Preferably each mounting member has a planar contact surface. Preferably each mounting member is connected to the other directly.

Preferably each mounting member is connected to the other indirectly by each being connected to the bracket.

Preferably the bracket is an intermediate member to the two mounting members.

Preferably one or both the mounting members are pivotally mounted to the bracket.

Preferably the two mounting members are hingingly engaged with each other.

Preferably the two mounting members are hingingly engaged to each other

Preferably the two mounting members are hingingly engaged to the bracket.

Preferably the hinging axis of each mounting member is parallel the other.

Preferably the hinging axis of each mounting member are at an acute angle to each other.

Preferably the bracket defines a pivot region for the strut assembly to allow the strut assembly to be supported by the bracket in a pivotable manner.

Preferably the two mounting members are spaced apart from each other.

Also herein described is an amphibious surface vehicle that has a mount as herein described attached to the bow.

Preferably the mount is attached on each side of the centreline of the bow or the or each hull of the vehicle.

Also herein described is a bow mount to secure a strut assembly that carries a wheel to convert a marine vessel into an amphibious surface vehicle, the bow mount comprising of two mounting plates dependent from which is a bracket presented to secure at least part of the strut assembly to and able to move relative to each other so that both plates can locate coplanar with a region of the hull in a manner to accommodate variations between hull shapes and locations are where the mount is to be secured.

Also herein described is a ground engagement assembly to be located at the bow of an amphibious surface vehicle comprising:

a strut assembly engaged or engageable to a hull of a marine vessel and that comprises a primary arm that carries directly or indirectly a ground engagement device (preferably a wheel) capable of being presented by the strut assembly in (a) a marine mode position where the ground engagement device is supported above the waterline of the vessel and (b) a land mode position where the ground engagement device is able to locate on the ground to support at least part of the hull above the ground, and wherein a primary actuator extends to the primary arm to move the ground engagement device between the ground mode position and the marine mode position, the strut assembly configures and adapted to be retrofitable to a hull without the need for the hull to be modified to receive the struts assembly during its movement between the marine mode position and the land mode position.

Preferably the strut assembly present the actuator in the land mode position, forward of the primary arm.

Preferably the strut assembly present the actuator in the land mode position, forward of a notional line between the actuation location of the actuator on the arm and where the arm is pivotally mounted to the hull of the vessel.

Preferably the strut assembly present the actuator in the marine mode position, above of a notional line between the actuation location of the actuator on the arm and where the arm is pivotally mounted to the hull of the vessel.

Preferably the strut assembly presents the actuator in the marine mode position, above the primary arm.

Preferably the primary arm is mounted to a strut mount that is secured to the hull of the vessel in a manner pivotable relative thereto.

Preferably the primary arm can move between a more vertical orientation when in the land mode position and a more horizontal orientation when in the marine mode position.

Preferably the actuator is a linear actuator.

Preferably the actuator is an electric, pneumatic or hydraulic actuator.

Preferably the linear actuator is a ram.

Preferably the linear actuator is secured relative the hull, proximate the hull and secured relative the primary arm, proximate the distal end of the arm away from the hull.

Preferably the linear actuator can cause the pivoting of the primary arm relative the hull.

Preferably the pivot axis of the primary arm is below where the linear actuator is secured relative the hull.

Preferably the pivot axis of the primary arm is more proximate the stern of the hull to where the ram is secured relative the hull.

Preferably the ground engagement assembly is a steerable ground engagement assembly comprising said strut assembly that comprises:
1) a primary arm pivotally mounted at a proximal end relative said hull, and
2) a steering knuckle, carrying said ground engagement device.

Preferably said steering knuckle is journalled from said primary arm toward its distal end away from the hull to allow a rotation of the ground engagement device in a manner to control the direction of motion of the ground engagement device over the ground when in the land mode position.

Preferably the linear actuator is provided to pivotally move said primary arm to move the ground engagement device between the ground mode position and the marine mode position.

Preferably the linear actuator can act on the primary arm at or near its distal end.

Preferably the steering knuckle is at least partially journalled to said primary arm intermediate of the proximal end of the primary arm and where the linear actuator acts on the primary arm.

Preferably the linear actuator extends only between the point of actuation on the primary arm and the location where it is pivotally mounted relative to the hull.

Also herein described is an amphibious surface vehicle comprising a hull and a ground engagement assembly as herein above described engaged to the hull the assembly and the location of engagement being such that no rebate of aperture is required through or into the hull dedicated specifically for the operation of the vehicle in both its land mode and marine mode.

Also herein described is an amphibious surface vehicle that includes a steerable ground engagement assembly as herein above described.

Preferably the amphibious surface vehicle comprises a hull.

Preferably the steerable ground engagement member is engaged to the hull at or near the bow.

Preferably there is only one steerable ground engagement member carried by the hull.

Preferably there are steerable two ground engagement members carried by the hull.

Also herein described is a powered locking hub assembly for supporting a wheel in a rotational manner relative a marine hull of an amphibious surface vehicle by a strut, the hub assembly comprising:

a motor housing presenting a motor having an output shaft, said motor housing held by the strut,

a hub member rotationally supported by the motor housing, the hub member comprising a hub and a hub flange by which a wheel can be mounted,

the hub member further comprising a clutch configurable between a condition (herein after “driving condition”) where it rotationally couples the output shaft and the hub member so that rotational output of the output shaft if transferred to the hub member and a condition (herein after “idle condition”) where the hub member is idle to any output shaft rotation.

Preferably the clutch comprises a clutch member that is supported for rotation with one of the output shaft and the hub yet can displace relative thereto between a position where the clutch member rotationally couples with the other of the output shaft and the hub so that rotational output of the output shaft is transferred to the hub member and a position where the hub is idle to any output shaft rotation.

Preferably the clutch member is coupled to one of the output shaft and the hub in a splined manner to allow linear displacement but no rotational displacement relative thereto.

Preferably the clutch member is splined to the hub.

Preferably the clutch member is splined to the hub internally of the hub.

Preferably the clutch member has castellations able to provide a complementary fit with the output shaft to assume the driving condition.

Preferably a clutch member actuator is secured to the hub, able to manually cause the clutch member to move between the coupled condition and idle condition.

Preferably the actuator is rotationally mounted relative the hub.

Preferably the actuator is mounted rotationally about the axis of rotation of the wheel.

Preferably the actuator and the clutch member or an intermediate member there between, have a cam and cam follower relationship to cause the clutch member to displace along the wheel axis of rotation.

Preferably the clutch member and output shaft are located in the hub member.

Preferably the actuator and the hub have an intermediate seal located therebetween to prevent ingress of water into the hub.

Preferably the motor housing includes a stub axle about which the hub is journalled.

Preferably the output shaft passes through the stub axle and into the hub member.

Preferably output shaft is presented for selective engagement by the clutch member at the distal end of the stub axle.

Preferably the clutch is a dog clutch.

Preferably the motor comprises a driven member and a gear box driven by the driven member, the output shaft being of the gearbox.

Preferably the gearbox is an epicyclic gearbox.

Preferably only the clutch transfers torque between the output shaft and the hub.

Preferably the output shaft if fixed relative the gearbox.

Preferably the powered locking hub assembly is waterproof to the standard of at least IP67.

Preferably the motor housing is secured to the strut.

Preferably the motor is an electric motor.

Preferably the motor is a hydraulic motor.

Also herein described is an amphibious surface vehicle comprising a marine hull that has a ground engagement assembly as herein described attached to it at its bow.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The invention will now be described by way of example only and with reference to the drawings in which:

FIG. 1 is a perspective view showing, in part in phantom, certain aspects of a preferred form of the amphibious surface vehicle,

FIG. 2 shows a perspective view of an amphibious surface vehicle utilising the ground engagement assembly as will herein be described,

FIG. 2a illustrates a side view of the hull of the amphibious surface vehicle of FIG. 2 wherein the bow wheel is stored within a recess of the hull,

FIG. 3 is a front view of a multihull version of an amphibious surface vehicle showing the bow ground engagement assembly positioned mid-ships at or towards the bow of the vehicle,

FIG. 4 is a section through section AA of FIG. 3 illustrating the bow ground engagement assembly in a land mode position and shown in phantom in a marine mode position,

FIG. 4a show the multihull having a cavity for the wheel and/or the strut assembly to at least partially retract into when in the marine mode,

FIG. 5 is a view of a rear section of a hull illustrating the two rear ground engagement assemblies, each engaged to for example a transom of the hull and showing such in the land mode position,

FIG. 6 is a rear view of the assembly shown in FIG. 5,

FIG. 7 is a side view of the assembly as shown in FIG. 5,

FIG. 8 shows the rear ground engagement assemblies in a marine mode position being where wheels are preferably elevated above the water line and preferably where the entire ground engagement assembly is above the water line of the vessel,

FIG. 9 shows a perspective view of the front of the hull at the bow and wherein a front ground engagement assembly is secured to the hull and shown in a land mode position,

FIG. 9a is a schematic side view showing components of the strut assembly of the front ground engagement assembly in a land mode position,

FIG. 9b shows a schematic side view showing components of the strut assembly of the front ground engagement assembly in a marine mode position,

FIG. 9c illustrates the arrangement of the ground engagement assembly in a schematic form also illustrating the steering knuckle and wheel to show schematically how a wheel may turn to steer the amphibious surface vehicle when moving across land,

FIG. 9D illustrates the arrangement of the primary arm and steering knuckle,

FIG. 10 is a perspective view of a bracket that may be used for engaging the strut assembly to a hull,

FIG. 11 is an alternative perspective view of FIG. 10,

FIG. 12 is a side view of the bow region of a amphibious surface vehicle showing the front ground engagement assembly in a land mode position,

FIG. 13 is a view from the bottom towards the hull showing the front ground engagement assembly in the land mode position,

FIG. 14 is a perspective view of the front ground engagement assembly but without the wheel being shown,

FIG. 15 is an alternative view of FIG. 14,

FIG. 16 illustrates an exploded view of the front ground engagement assembly,

FIG. 17 shows the bow portion of the amphibious surface vehicle where the front ground engagement assembly is in a marine mode position,

FIG. 18 shows a perspective view of the front ground engagement assembly in the marine mode position,

FIG. 19 shows the front ground engagement assembly steering mechanism,

FIG. 20 is an alternative view showing the steering mechanism of the ground engagement assembly,

FIG. 21 is an alternative view showing how the steering mechanism may operate relative to the steering knuckle and primary arm,

FIG. 22 is an alternative perspective view of the steering mechanism,

FIG. 23 shows the front ground engagement assembly with a hydrodynamic deflector in a stowed condition when the strut assembly is in the land mode position so as to allow for the wheel to roll across land without interference from the hydrodynamic deflector,

FIG. 24 shows the hydrodynamic deflector in an in use mode positioned to cover the wheel in a position so as to deflect water spray that may impinge on the wheel from the front to deflect such away from the wheel and/or the hub,

FIG. 25 is a perspective view of the hydrodynamic deflector and the mechanism that may be utilised for moving it between a stored position and in an in use position,

FIG. 26 is a sectional view of a locking hub that may be utilised for putting the wheel in a condition where it can be driven by an actuator such as a hydraulic or electric motor and in a position where the wheel can move idly independent of such motor,

FIG. 27 is a perspective view of an alternative arrangement of a bow ground engagement assembly when in the marine mode,

FIG. 28 is a bottom view of FIG. 27,

FIG. 29 is a side view of FIG. 27,

FIG. 30 is a perspective view of an alternative arrangement of a bow ground engagement assembly when in the land mode,

FIG. 31 is a side view of FIG. 30,

FIG. 32 is a view of the bow ground engagement assembly in the land mode position, and

FIG. 33 is a view of the bow ground engagement assembly in the marine mode position.

### DETAILED DESCRIPTION OF THE INVENTION

An amphibious surface vehicle 1 of the present invention may comprise of a marine vessel having a hull 2. Dependent from the hull may be a plurality of ground engagement assemblies 3a, 3b and 3c. The engagement assemblies may be each of a different configuration. In preferred form there are three ground engagement assemblies. There may be two at the rear of the hull 2 and preferably one at the front of the hull. It will be appreciated that further ground engagement assemblies may be provided, for example where two of such are positioned at the rear of the hull 2 and two at the front of the hull.

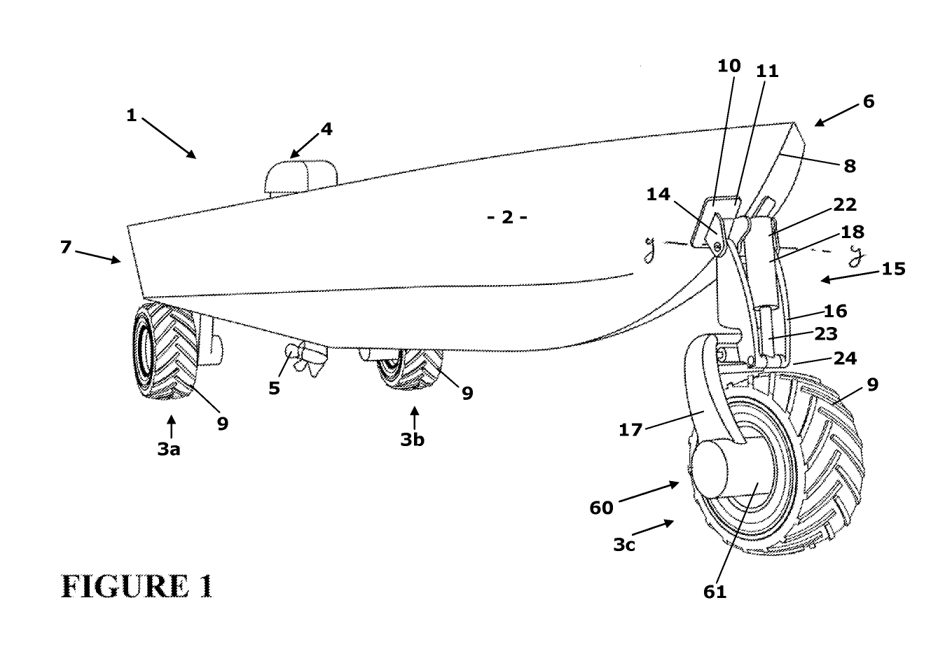

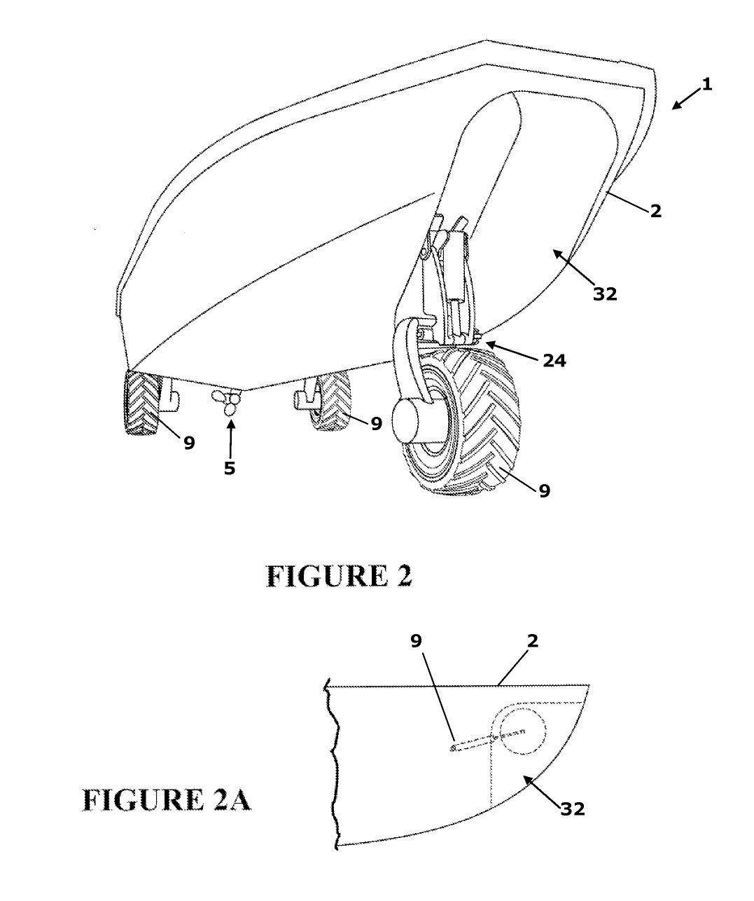

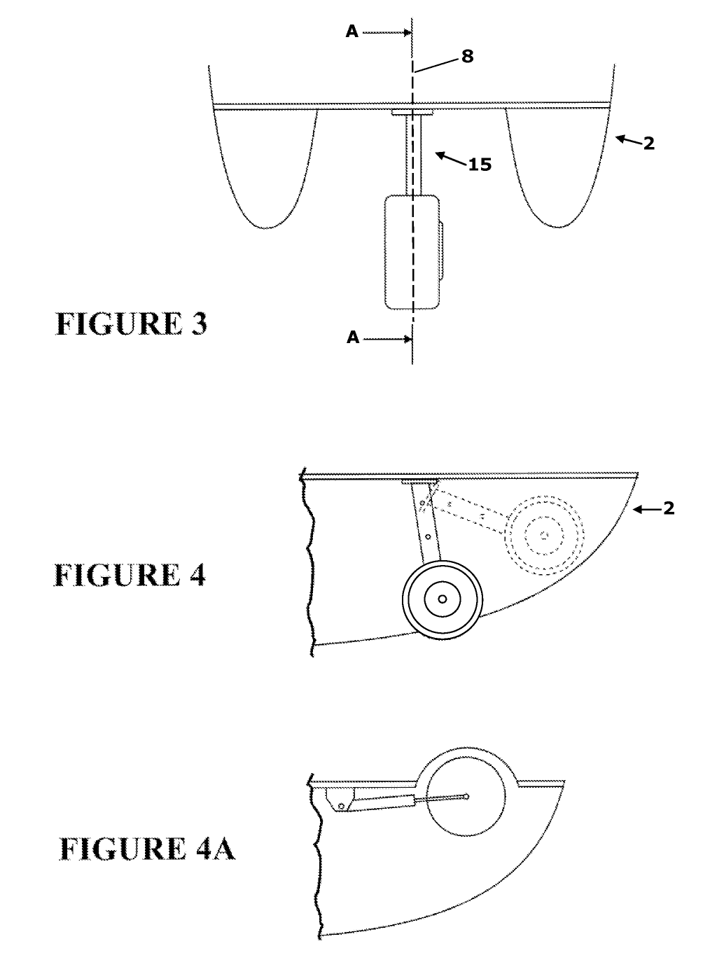

The hull 2 may be a mono hull as shown for example in FIGS. 1 and 2. It may instead be a multi hull as for example as shown in FIGS. 3 and 4. The hull is preferably a plaining hull. It may be propelled, when the amphibious surface vehicle 1 is in a marine mode, by a marine propulsion device 4. The marine propulsion device 4 may be an outboard motor or a inboard motor powering a jet unit or propeller 5 that is submerged when the amphibious surface vehicle is in its marine mode.

The inboard or outboard motor may also provide power for the operation of the ground engagement assemblies for their lifting, lowering and/or steering. Such power may also be utilised for their driving.

The hull 2 has a bow 6 and a stern 7. It also has a centreline 8 extending mid-ships along the length of the vessel.

In a preferred form at least some and preferably all of the ground engagement assemblies are able to be retrofitted to a hull.

With reference to the example shown in FIG. 1, three ground engagement assemblies are shown. There are preferably two at the stern 3a, 3b and one at or near the bow 3c. The stern ground engagement assemblies provide ground engagement devices (eg. wheels or a track or other form of ground contact and device 9), that are spaced apart from each other. Likewise the ground engagement device 9 of the front ground engagement assembly 3b is spaced apart from those at the stern one ground engagement assembly with two spaced apart wheels may also be an option. This creates a stable platform for when the amphibious surface vehicle is in a land mode as shown in FIG. 1. The ground engagement device will hereinafter be referred to as the wheel for convenience.

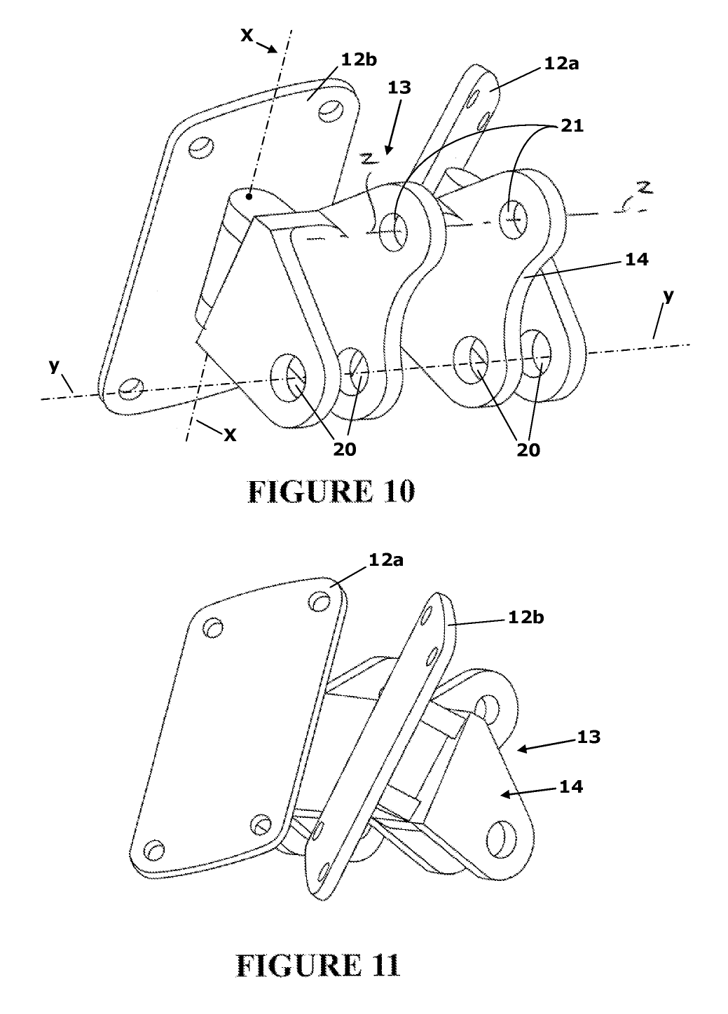

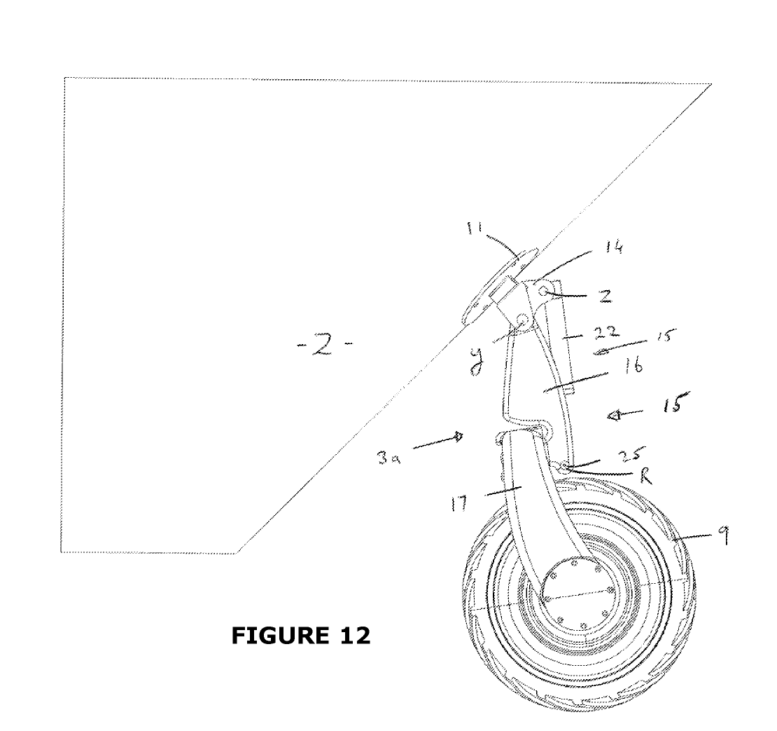

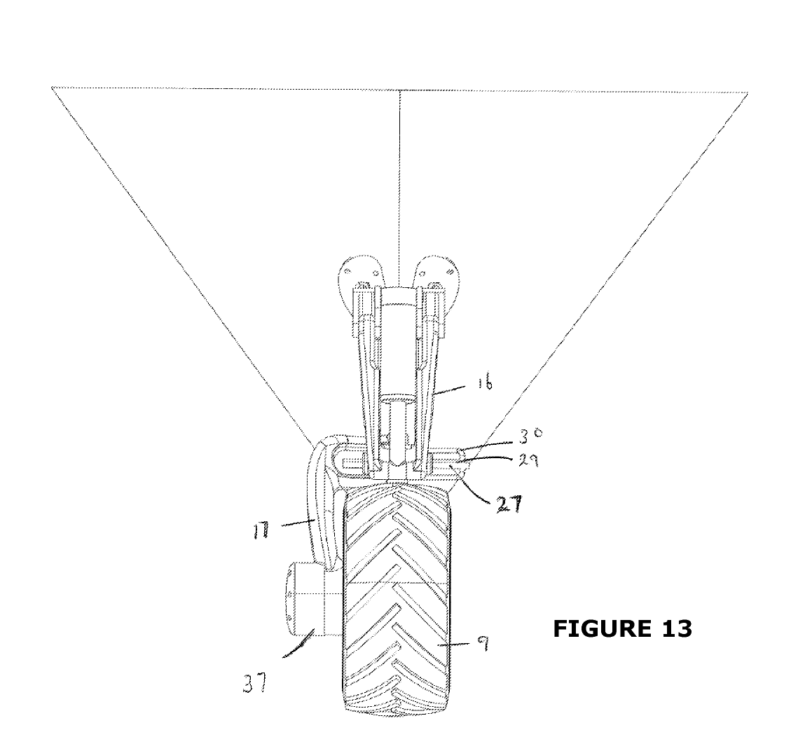

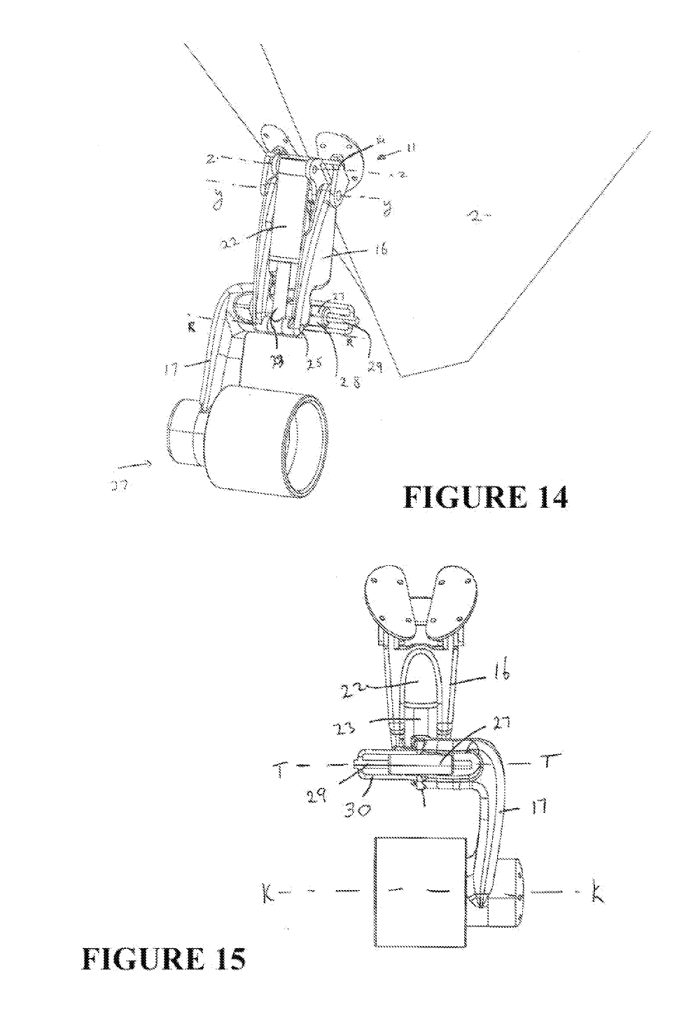

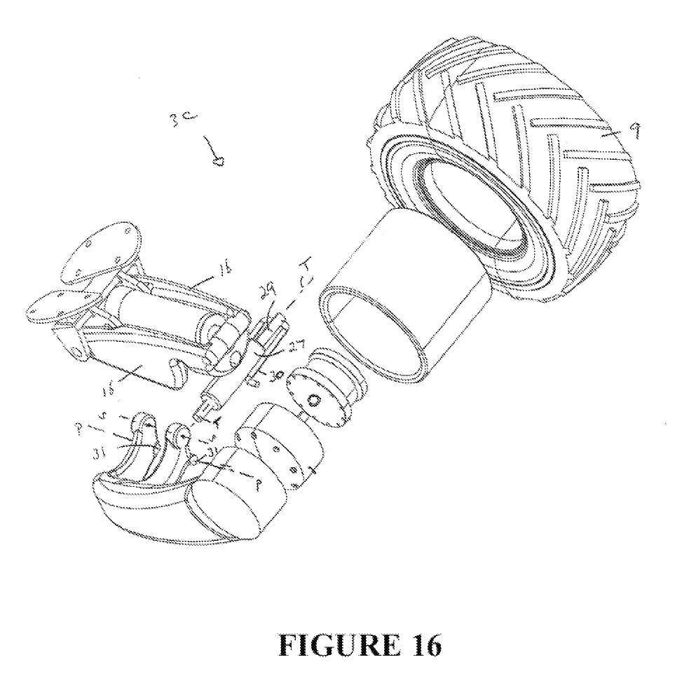

With reference to the ground engagement assembly 3c as shown in FIG. 1, it is preferably mounted to the hull 2 about the centreline 8. This places the front ground engagement assembly at mid-ships. A mechanical fixing such as by way of bolts 10 can allow for a mount 11 to be secured to the hull. The bolts 10 may penetrate through the hull to securely fasten the ground engagement assembly 3c to the hull. In order to allow for such a front ground engagement assembly to be engaged to various forms of hulls, the mount 11 as shown with reference to FIGS. 10 and 11 may comprise of two mounting members 12a and 12b. The mounting members 12a and 12b may for example be plates that can locate substantially coplanar with different portions of the hull at where the mount 11 is to be engaged. As hull forms of marine vessels vary in shape and size, the bow section of hulls will be of different geometry. The mount members 12a and 12b are able to move relative to each other to accommodate such variation. This facilitates on easy retrofit of the mount to many forms of hull.

In order to be able to be configured to a condition to locate against the respective sides of a hull about a centreline, the mounting members can move relative each other. The mounting members 12a and 12b may for example be mounted from a bridging portion 13 in a pivotable or swivelable manner. For example the mounting member 12b may be engaged to the bridging portion 13 for pivoting about the axis XX by virtue of an axle or pivot arrangement. Likewise the mounting member 12a may so be pivoted relative to the bridging member 13. This allows for the angle between the mounting members 12a and 12b to be varied so as to be able to accommodate geometries of different hulls. A further swivel mechanism may also be provided. This may pivot about an axis orthogonal to axis XX to allow for further degrees of freedom of positioning of mounting members 12a and 12b relative each other. The bridging member 13 may for example include a swivel joint that can rotate in a direction that is parallel to an orthogonal axis XX or some other axis that is not parallel to XX. An alternative orthogonal axis may however not be necessary. It may merely be the axis XX for each of the mounting members that can allow for the mount 11 to be adapted for secure engagement about a centreline 8 of the hull 2 or to other parts of the hull.

It will be appreciated that with such capacity to be reconfigured the mounting members may also be positioned to other parts of the hull not necessarily about the centreline 8 but where surfaces that may be variable from vessel to vessel may be provided.

The bridging portion 13 includes a bracket 14 that is presented to allow for the strut assembly 15 to be dependent therefrom. Preferably the strut assembly and bracket engage in a manner to allow for a single axis rotation YY of the primary arm 16 of the strut assembly to be established. This allows for a movement of the ground engagement assembly between a land mode position and a marine mode position.

The strut assembly 15 for a steerable ground engagement assembly (such as the ground engagement assembly 3c) preferably comprises of a primary arm 16 and a steering knuckle 17. The primary arm 16 is by way of an actuator 18 able to be moved in a pivotal manner about pivot axis YY relative to the hull. This moves the ground engagement assembly 15 between a marine mode position and a land mode position. In the marine mode the ground engagement assembly presents the wheel 9 above the waterline of the hull. It preferably presents it at least in part above the gunwale of the hull. It may present it within a cavity or rebate in the hull. This is the stowed position of the wheel.

In a land mode the ground engagement assembly 15 is positioned to presents the wheel in a manner for holding the hull 2 above the ground. In a preferred form all of the ground engagement assemblies (such as ground engagement assemblies 3a, 3b and 3c) act in unison. Preferably they move in unison. Alternatively each can be separately controlled. It may for example be possible to lower the stern of the hull onto the ground keeping the bow supported by the front ground engagement assembly.

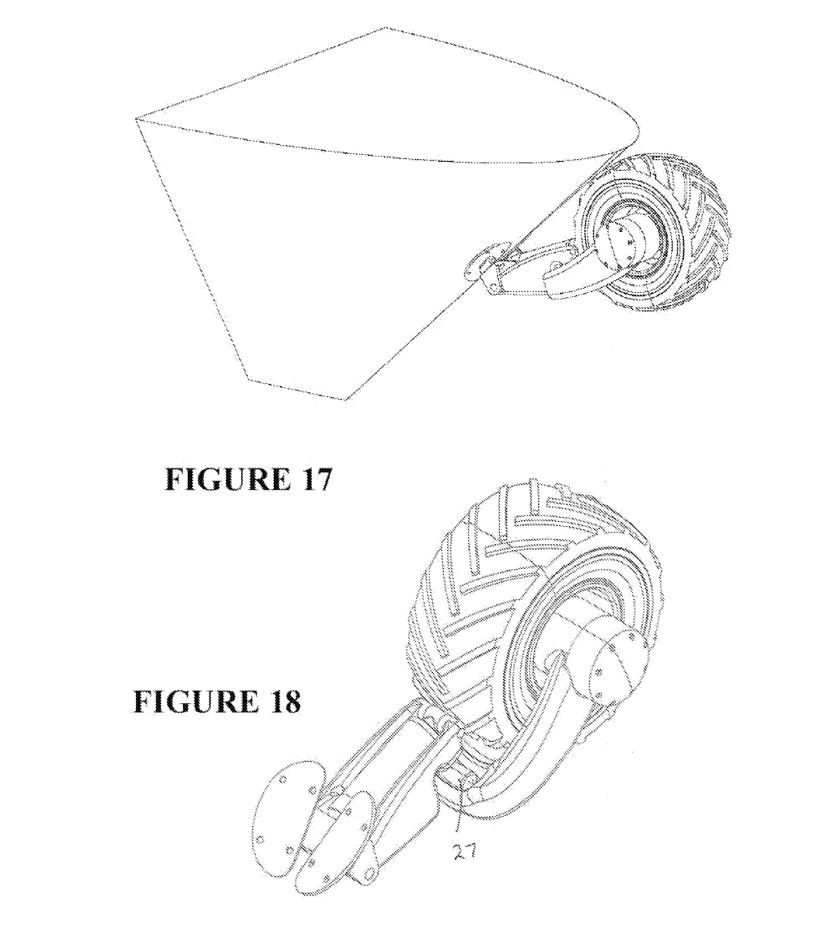

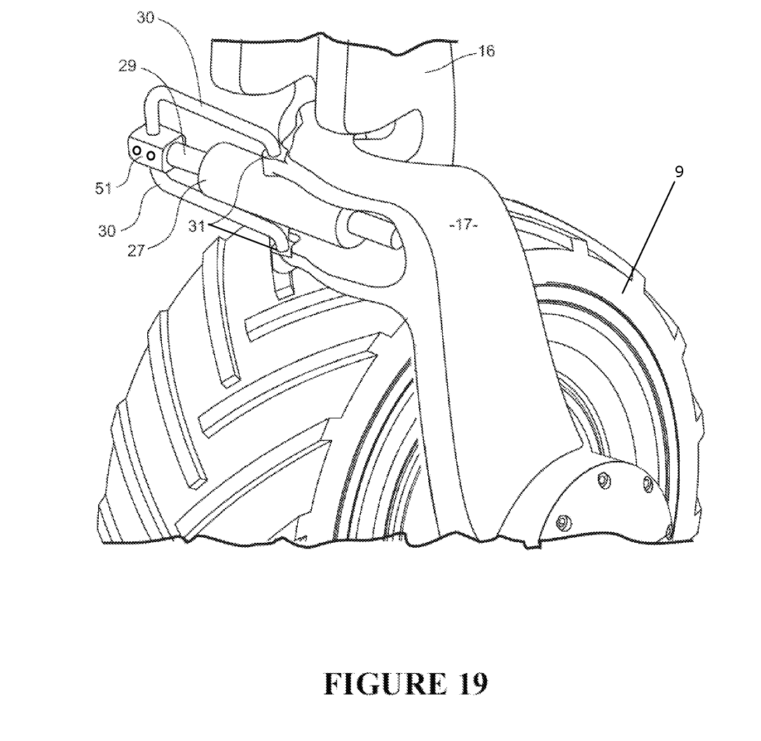

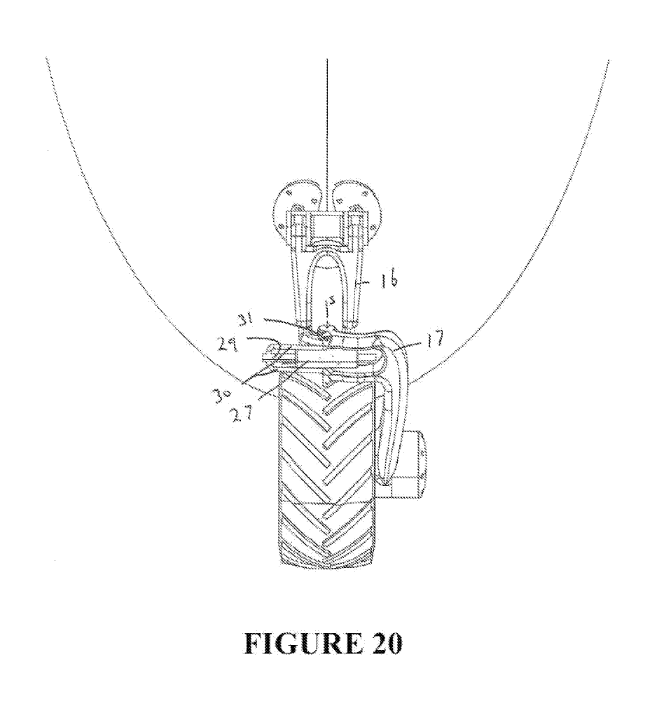

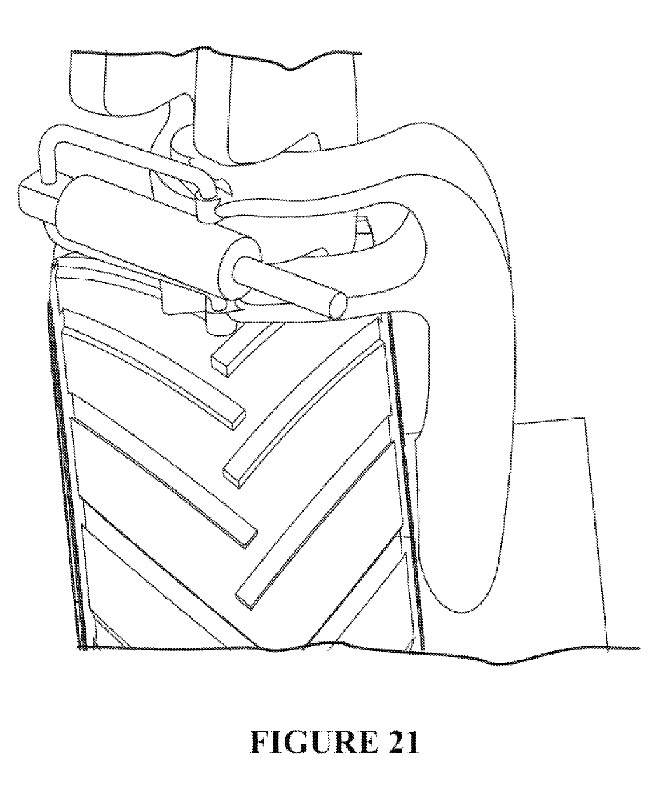

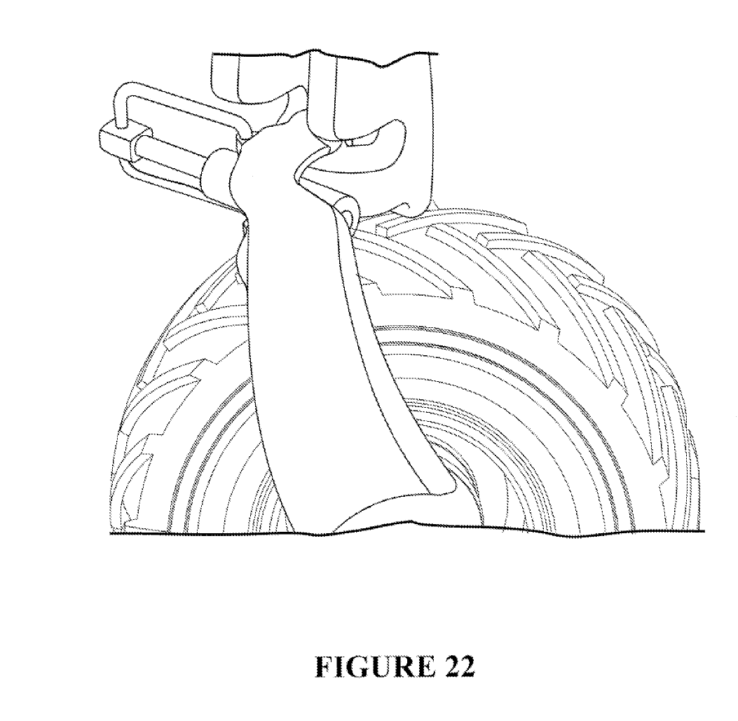

The primary arm 16 is able to rotate between its marine mode position and land mode position on the axis YY. It is preferably constrained for rotation/movement relative the hull, other than rotation on axis YY. This axis YY may be defined by a fulcrum pin 19. The fulcrum pin 19 may pass through the apertures 20 of the bracket 14. The primary arm 16 preferably has only one axis of rotation for its movement between the marine mode position and land mode position. In FIG. 1 the strut assembly 15 is shown in the land mode position whereas in FIG. 17 it is shown in an exemplary marine mode position where the wheel has been pivoted forwards and upwardly relative the hull from the ground mode position. It will be appreciated that in some hull forms and/or in certain positions of the front ground engagement assembly, the wheel may be pivoted backwards and upwards in moving from a land mode position to its marine mode position. For example where the ground engagement assembly is engaged to a multihull as shown for example in FIGS. 3 and 4, the clearance under the hull between the two adjacent pontoons may be such that the strut assembly can either pivot forwards or backwards in moving from a land mode position to a marine mode position.

The hull may include a cavity for the wheel and/or the strut assembly to at least partially retract into when in the marine mode as shown in FIG. 4a.

In a preferred form the primary actuator 18 is a hydraulic ram arrangement 18 as shown in FIG. 1. It is preferably a double acting ram. It may alternatively be a single acting ram for lifting the strut assembly to the marine mode position. Gravity causing movement in the opposite direction. An over centre or lock out pin mechanism may be used to hold the assembly in the land mode position.

In an alternative embodiment the actuator may be a rack and pinion style actuator utilising a rotary driver such as a hydraulic or electric motor to move the strut assembly.

To establish mechanical leverage yet be of a compact design, in order for the hydraulic ram 18 to be able to pivot the primary arm 16 about its pivot axis YY as well as being able to hold the strut assembly in position for both marine mode use and land mode use, the hydraulic ram is preferably positioned for rotation relative to the hull at a position away from the axis YY. For example the hydraulic ram may be secured at the axis ZZ. Axis ZZ may be defined by the bracket 14. The ram will act in a direction perpendicular to the axis ZZ and also preferably perpendicular to the axis YY. A suitable pin or axle may extend through the apertures 21 of the bracket 14 to mount preferably the cylinder 22 of the hydraulic ram 18. Axis ZZ is preferably close to axis YY. This allows both the primary arm and the ram to be mounted to the bracket that can be secured at one location to the hull of the vessel. This is beneficial for retrofit purposes and for requiring any requisite hull reinforcing to be limited to one zone at and around where the bracket is mounted. It also keeps the space occupied by the assembly small and not spread out.

The hydraulic ram 18 can preferably pivot about the axis ZZ as the primary arm 16 pivots about its axis YY during the movement of the strut assembly between the marine mode and land mode. The hydraulic ram 18 also includes a hydraulic piston rod 23. It is engaged preferably at the distal end 24 to and of the primary arm 16. A fulcrum pin 25 may be provided to establish a pivot axis RR that is preferably parallel to the axis YY. It is also preferably parallel to the axis ZZ.

The positioning of the axis ZZ, YY and RR is such that the movement of the strut assembly between the marine mode position and the land mode position does not require for any modification to the hull to be made other than for the purposes of securing the ground engagement assembly thereto. Eg by way of the mount/bracket. The strut assembly in both positions remains clear of the bow of the hull of the vessel and does not need to protrude in any part, into the hull of the vessel. For the bow ground engagement assembly, axis YY is preferably lower than axis

ZZ. Axis RR is preferably lower than axis ZZ and YY when the strut assembly is in the land mode position. Axis ZZ is forward more of YY. Axis RR is preferably forward more of axis YY and ZZ in both the land mode and marine mode.

The distance between axis ZZ and YY is less than the distance between YY and RR and ZZ and RR. It is preferably less than 50% the distance and preferably less than 25% the distance and preferably less than 10% the distance.

In the form as shown in FIG. 1, the strut assembly 15 in moving from the land mode position to the marine mode position may pivot forwards and upwards. This is achieved as a result of the retraction of the piston rod into the hydraulic cylinder 22. This causes the distance between the axis ZZ and RR to be reduced thereby causing a pivoting motion of the primary arm 16 about its fulcrum YY. In a preferred from the axis RR is located as proximate as possible to the wheel 9 and its perimeter 9. This ensures significant mechanical advantage is established and providing for large stroke length of the ram. Axis ZZ is preferably outside the profile of the bow of the hull of the vessel. Preferably so is axis YY.

The cylinder 22 preferably extends solely between axis ZZ and RR.

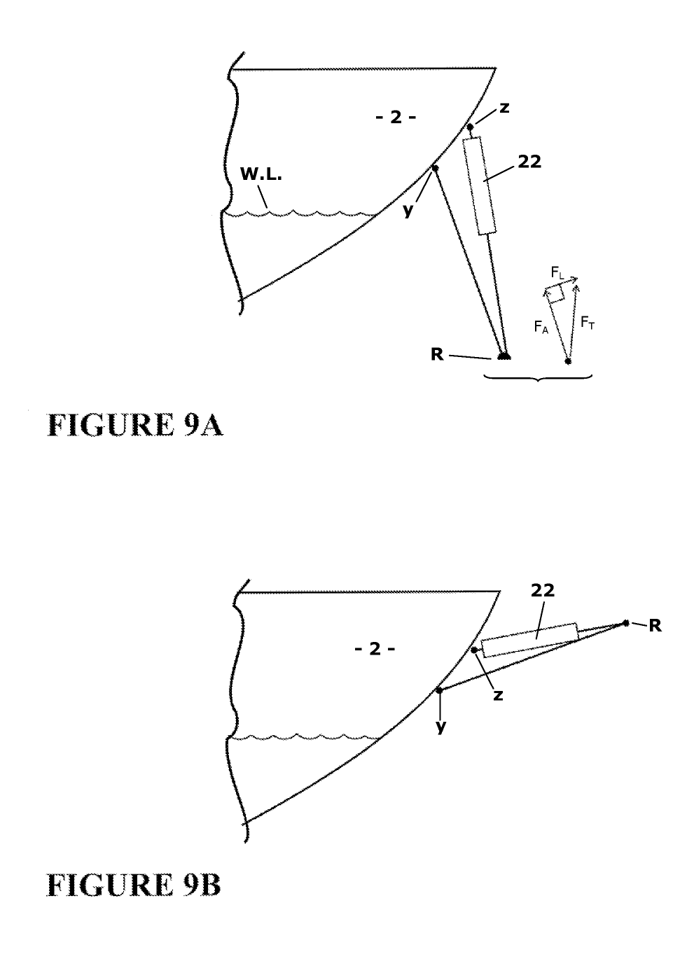

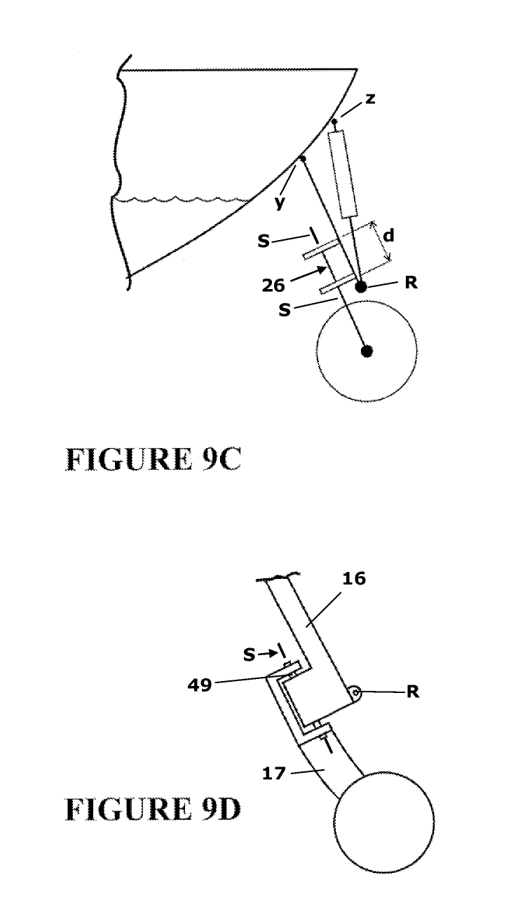

The mechanical advantage geometry is for example shown with reference to FIGS. 9a and 9b. In FIG. 9a there is also reference to the force diagram showing the force FT being the total force applied by the actuator to the primary arm between axis R and Y being a vector sum of the force FA and force FL. Were axis RR to be more proximate to axis YY, then a shorter stroke length would exist for the actuator and in addition a higher capacity would be required in order to ensure that in both the marine mode position and land mode position of the strut assembly, the primary arm is rigidly held in position. In the marine mode position it is merely the carrying of the weight of the strut assembly that is required to be taken into account in the geometry design. However in the land mode position forces encountered by the strut assembly of the wheel rolling and/or being driven across land may be more significant. Therefore having the ram acting on the primary arm as proximate as possible to the perimeter of the wheel is desirable.

The primary actuator may instead be a morse cable, chain and sprocket arrangement, linear motor or other that can exert force between the primary arm and the hull for controlling the movement and position of the primary arm relative the hull.

To allow a sufficient capacity hydraulic ram to be used yet keep the axis ZZ close to axis yy, the primary arm may be bifurcated or have a rebate in it to allow at least part of the ram to located in the slot/rebate. Alternatively the ram may be located laterally adjacent and external of the primary arm. Two rams may be provided, one on each side of the primary arm. But preferably one ram is used and it is preferably located on the centreline of the vessel and concentric the primary arm when viewed from the front of the vessel. The ram's axis of actuation is preferably parallel a notional plane in which axis SS lies. A notional plane in which the ram's axis of actuation lies is preferably coplanar a notional plane in which axis SS lies.

In order for the ground engagement assembly 3c to be able to steer the amphibious surface vehicle 1 the steering knuckle 17 is journalled from the primary arm 16.

In order to ensure significant rigidity is established between the steering knuckle 17 and the primary arm 16 it is desirable to position the journalled connection at a location where it can obtain substantial lateral resistance to a pivoting in a direction parallel to the axis of the wheel. Ie to resist bending of the strut assembly.

Rather than placing the journalled connection at a location substantially or entirely at the primary arm that is opposite the RR axis to the proximate end of the primary arm, the journalled connection is at least in part established more proximate to the proximate end of the primary arm. This also helps reduce the requirement of the primary arm to extend beyond where axis RR is provided so that the primary ram can act as close as possible to the periphery of the wheel. The journalled coupling may be provided by a pivot pin 49 that is supported by two fork elements of the primary arm or of the steering knuckle and to which the other of the primary arm or steering knuckle is engaged in a manner to be able to pivot. The two fork elements are preferably well spaced apart to help take the locking on/off the wheel.

With reference to FIGS. 9c and 9d it can be seen in schematic that the pivot pin 49 is preferably located at a position of the primary arm 16 intermediate of the axis RR and YY. Or at least one part of that pivot mechanism is located on the YY axis side of the RR axis. Having at least part on the YY axis side of the arm allows the distance of load transfer by the forks to be well spaced apart yet keeping RR close to or at the end of the arm 16. The pivot axis is preferably at the steering axis SS. Bending moment forces applied by the steering knuckle can be transferred to the primary arm at well spaced apart locations to give good strength to the connection between the primary arm and the steering knuckle.

The steering knuckle is able to rotate about the axis SS relative to the primary arm 16. Such movement may be in an idled manner such as for example when the amphibious surface vehicle is being towed. Such towing may be achieved by engaging a bridal to the wheel such being for example coupled to a tow bar engaged to a towing vehicle such as a tractor for moving the amphibious surface vehicle across the land. Alternatively the steering knuckle may have its rotational position relative to the primary arm determined by the use of a steering actuator 27.

The steering actuator may be a linear actuator. Such is preferably a hydraulic ram. It preferably has a cylinder portion 28 and a piston ram 29. One of the cylinder portion and piston ram 29 may be secured to a coupling such as a reaction bar 30 that is coupled to both the piston rod and the steering knuckle at pivots 31. The cylinder of the steering actuator may be secured to the primary arm thereby allowing for reaction force to be established between the steering knuckle and primary arm for the purposes of pivoting the steering knuckle 17 about the axis SS relative to the primary arm 16 for the purposes of controlling the rotational position of the wheel relative to the axis SS for steering the amphibious surface vehicle. In the preferred form the reaction bar 30 is connected symmetrically to both the steering knuckle 17 and to the piston rod 23 of the steering actuator 27. As a result, when the piston rod of the steering actuator 27 applies a force to the reaction bar 30 the load transferred to the steering actuator 17 is symmetrical about the operational axis TT of the steering actuator 27. Preferably this axis TT is perpendicular to an orthogonal to the axis SS. The pivots 31 are on an axis PP that is offset from the axis SS but parallel thereto.

The steering actuator may instead be a morse cable, chain and sprocket arrangement, linear motor or other that can exert force between the primary arm and the steering knuckle.

The steering actuator may be decoupled from one of the primary arm and steering knuckle so that the steering knuckle can be made idle. The wheel, when the steering knuckle is in such a condition, may act as an idler wheel to allow for example a towing of the vehicle as previously described.

A pin or fastener or coupler 51 may be used to decouple the steering actuation in such a manner. The coupler can physically disconnect the reaction bar 30 from the ram. The ram may then remain in a fixed disposition without feedback forces needing to be taken care of as a result of any towing steerage input applied by the tow vehicle. Towing with the ram still engaged may make turning of the wheel difficult and/or cause hydraulic feedback.

The steering actuator 29 and/or the primary actuator 18 are preferably double acting rams.

As can be seen with reference to FIG. 2, the hull may include a rebate 32 at its bow region. The rebate is of a shape and configuration to allow for the ground engagement assembly to be fully retained within the rebate 32 when the strut assembly is in the marine mode position. The rebate 32 may include a cover (not shown) that can move between a position allowing for movement of the strut assembly between the marine mode position and land mode position the cover extending across the substantial part of the mouth of the rebate 32 at least when the strut assembly is in the marine mode position thereby enclosing it within a cavity so created. In FIG. 2a the wheel 9 is shown within the confines of the rebate 32 of the hull 2.

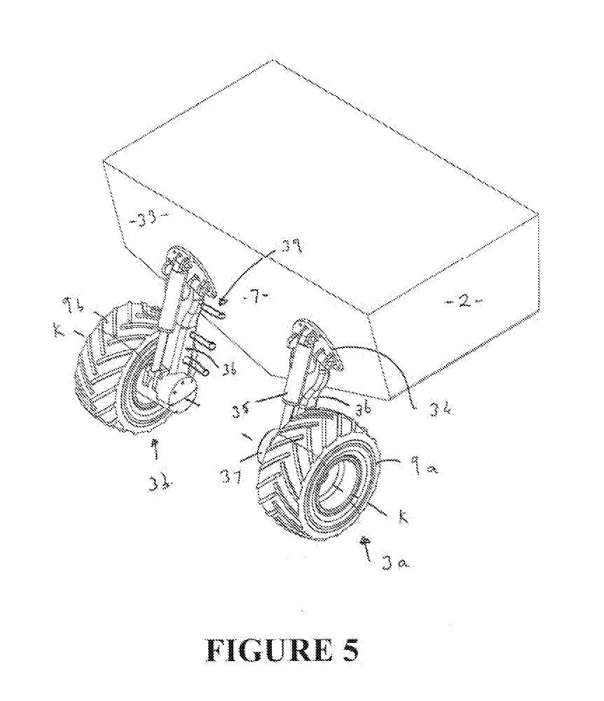

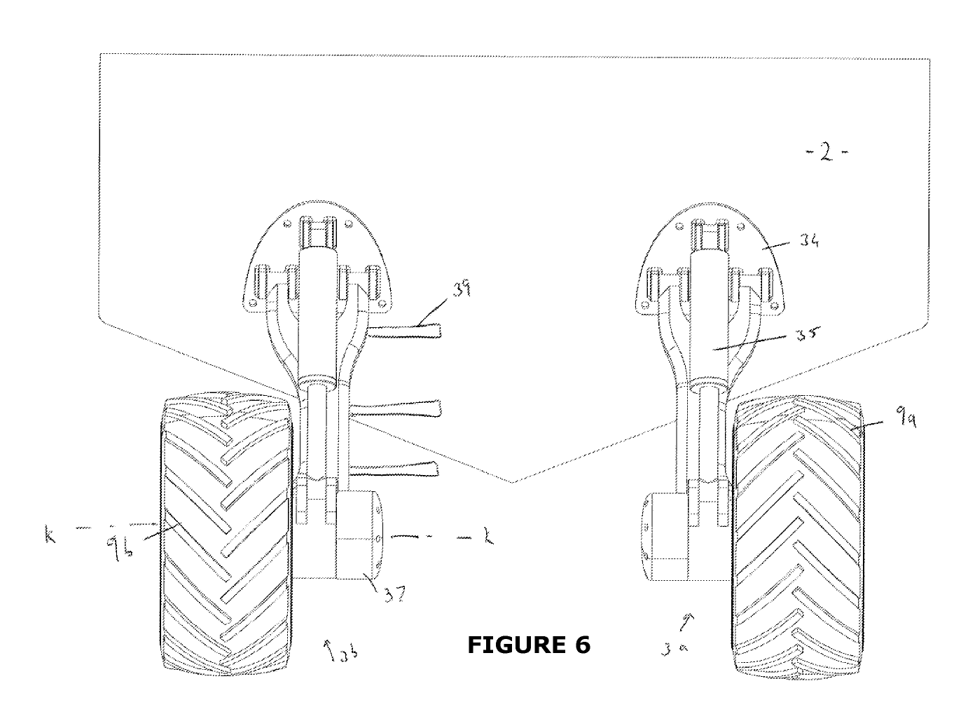

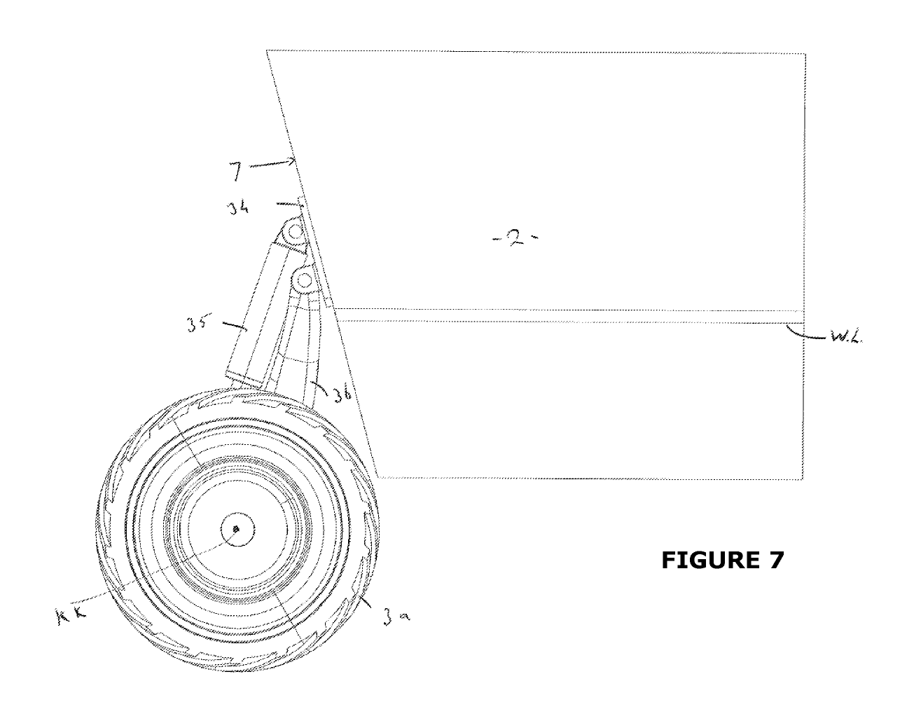

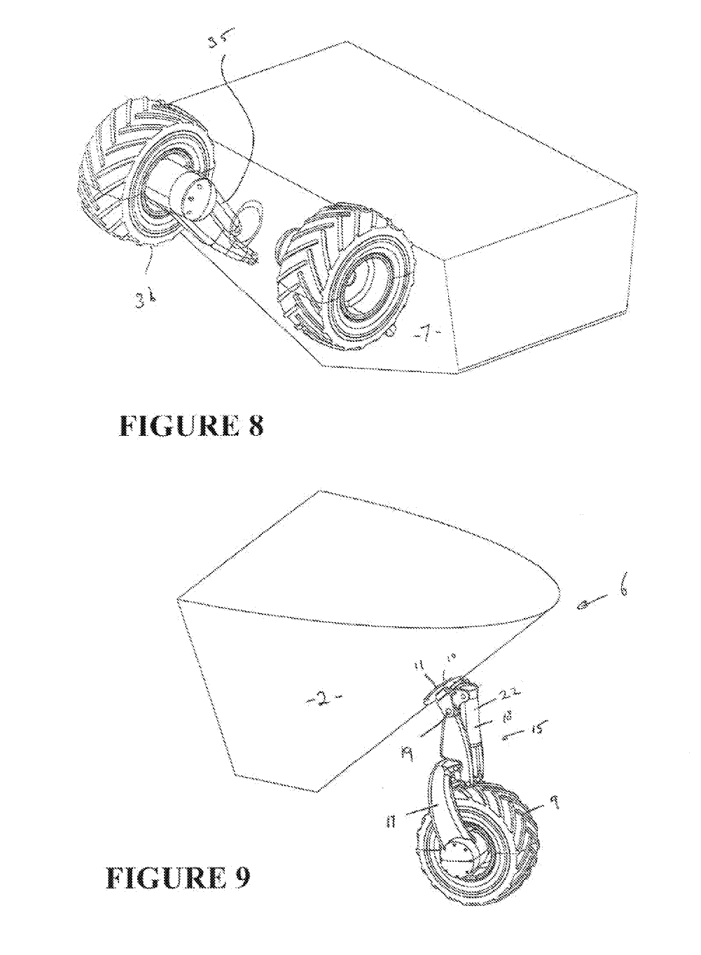

With reference to FIG. 5 there is shown the stern positioned ground engagement assemblies 3a and 3b. The stern ground engagement assemblies are preferably mirror images of each other. The stern ground engagement assemblies preferably include a similar or the same ground engagement device 9a and 9b respectively. Such is preferably a wheel able to be driven or be idle for rotation about the axis KK. Preferably this axis is perpendicular to the centreline of the hull of the amphibious surface vehicle.

The rear ground engagement assemblies 3a and 3b are preferably not steerable. Alternatively they are.

The rear ground engagement assemblies 3a and 3b are preferably secured or securable to a transom 33 of a hull 2. Mounting plates 34 may be provided for such purposes. They may be bolted to the transom. Each rear ground engagement assembly may be moved between a marine mode position and a land mode position by the use of an actuator 35 such as a hydraulic ram, which can control the position of a strut 36 pivotally connected between the hull 2 and the hub 37 of each of the wheels. Forming part of the rear ground engagement assembly may be a step or rungs for a ladder 38 as can be seen with reference to the ground engagement assembly 3b. The plurality of rungs 40 may be engaged to for example the strut 36 to move therewith. Such may allow for a boarding ladder to be defined to allow a person to climb onto the vehicle 1 when for example the rear ground engagement assembly is in the land mode position. Alternatively a boarding step or ladder may be secured to the hub 37 and/or to the mounting plate 34.

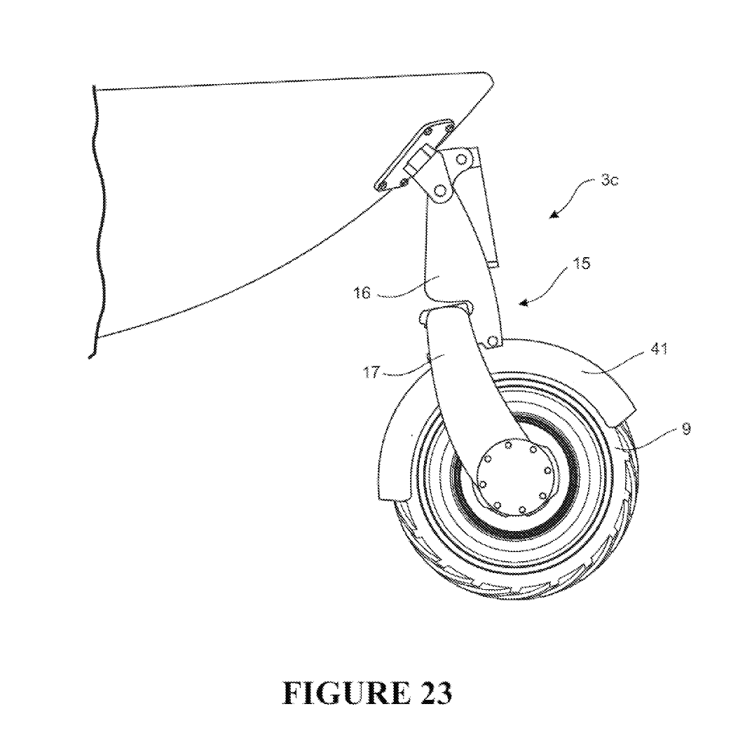

With reference to FIGS. 23-25, there is shown a front ground engagement assembly 3c that includes a cover 41. The cover 41 preferably covers at least part of the ground engagement device 9 from at least some directions. The cover 41 may for example be in the form of a mud guard and may locate adjacent to the wheel 9 over a certain arc about the pivot axis of the wheel. The cover 41, when the ground engagement assembly is in the land mode position as shown in FIG. 23, can act as a mud guard. It is positioned relative to the ground in a manner so as to not interfere with the motion of the wheel over the ground.

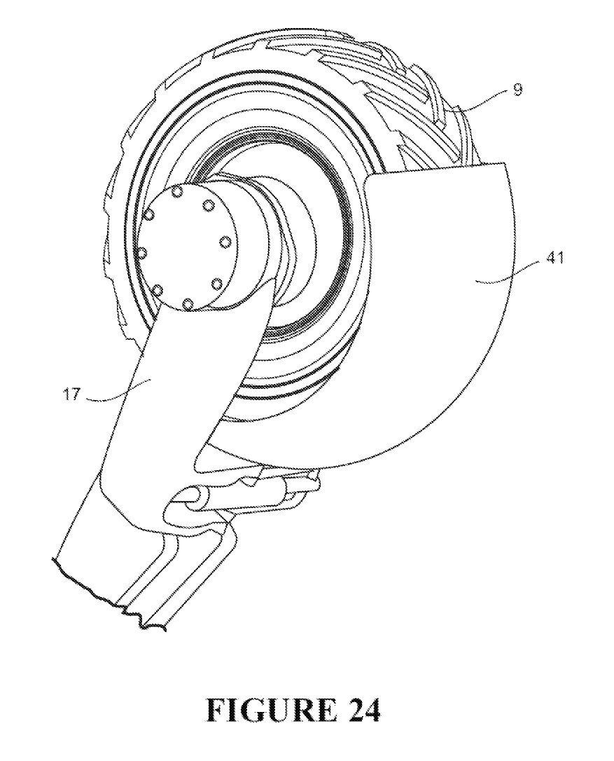

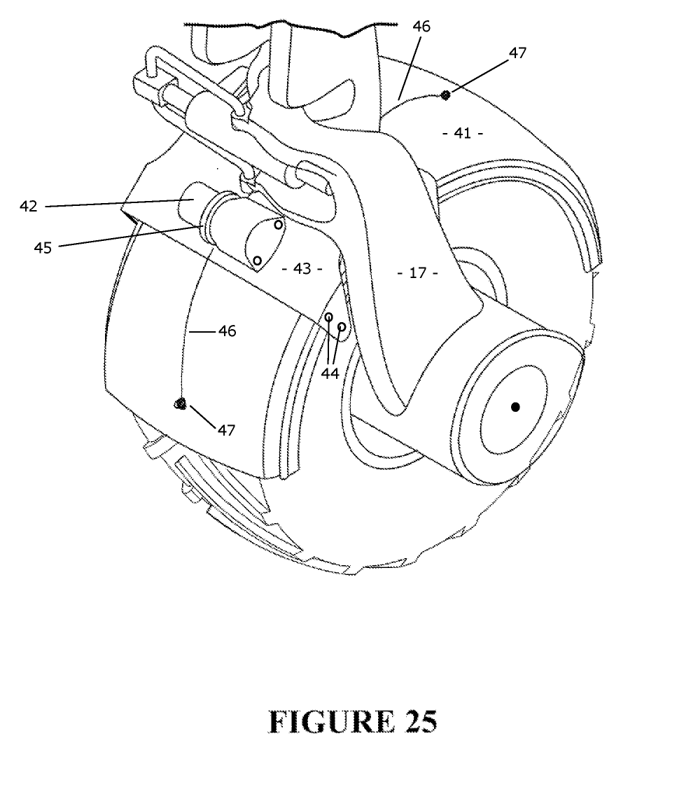

The cover 41 is preferably supported by the strut assembly 15. It is preferably supported by the steering knuckle 17 so that it rotates with and as the steering knuckle 17 is rotated relative to the primary arm 16. In moving from the land mode position as shown in FIG. 23 to the marine mode position as shown in FIG. 24, the cover 41 may move relative to the steering knuckle 17. It may move to a position where it is presented in a manner to cover at least part of the ground engagement device 9. In particular it is presented to cover at least part of the ground engagement device against any incident water spray by the vessel as it moves through the water. Bow spray may be deflected upwards by the hull of the vessel and/or waves may directly impinge onto the cover and/or the vessel and thereafter be caused to move against the cover 41. The cover 41 provides a hydrodynamic as well as aerodynamic deflection of impinging fluid flow. The cover 41 in the orientation as shown in FIG. 23 may hence move in a counter clockwise direction about the axis of rotation of the wheel when the ground engagement assembly is moved from the land mode position to the marine mode position as shown in FIG. 24. Such movement may be caused by a motor 42 as shown in FIG. 25. This motor may be an electric or hydraulic motor. The cover 41 may be mounted by a guide 43 that is engaged to the steering knuckle 17. The guide 43 may have a plurality of guide members 44 that can hold for example an edge or lip or rim of the cover 41 in a manner to allow for it to still rotate about the axis of rotation of wheel. The motor may include a pulley 45 about which or relative to which a cable 46 may be placed that is secured at anchor points 47 to the cover 41. The pulley 45 upon its rotation by the motor 42 can cause the cable displace thereby pulling with it the cover 41 in an appropriate direction fully positioned for either the land mode or the marine mode of the amphibious surface vehicle. A rack and pinion mechanism may instead be used.

At least one of the wheels may be driven where the vehicle is to be of a kind that can self propel over ground. This may be achieved by incorporating a motor. The motor may be a direct drive motor or use a gear or drive train or other to turn one of each of the wheels. Preferably the motor is a hydraulic or electric motor.

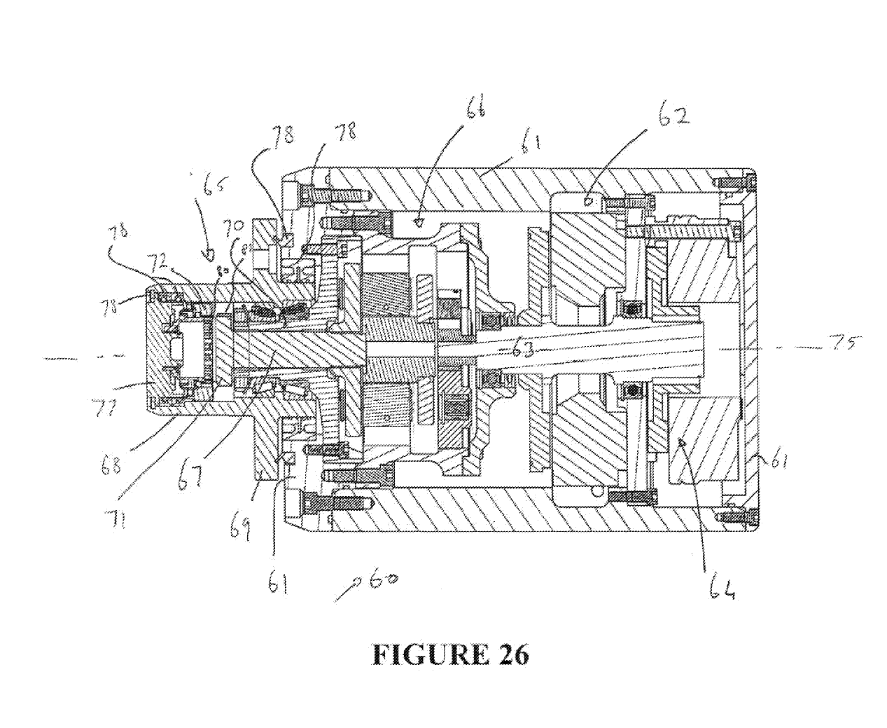

The wheels may be supported by a powered locking hub assembly 60 as shown in FIG. 26. It may include a motor housing 61 that is able to secure or is secured to the strut assembly. It is preferably securable to the steering knuckle if steering function is desired. Within the motor housing may be a motor 62. This may be an electric motor having a drive shaft 63. The drive shaft may be a braked driveshaft with or by which a brake mechanism 64 may interact.

The driveshaft 63 may be the output shaft for engagement by the hub member 65. Alternatively the driveshaft may power a reduction gearbox 66 that is preferably also housed in the motor housing. The gearbox is preferably an epicyclic gearbox. An output shaft 67 from the gearbox is preferably presented to drive the hub member 65.

The motor 62 is preferably a rotary motor such as an electric motor or hydraulic motor.

It may be controlled from onboard the marine vessel.

The hub member 65 may comprise of a hub 68 and a hub flange 69 on which a wheel may be mounted. Such mounting may be secured by the use of bolts and nuts.

The hub member is supported on a stub axle 70 of the motor housing. The output shaft preferably extends through the stub axle and into the hub. The hub is preferably hollow. The Output shaft may have a terminal end 71 with which a clutch member 72 and selectively engage. The clutch member is preferably splined to the hub so that it is rotated therewith but cam move along the axis of rotation 75 of the wheel, the output shaft and motor.

The clutch member can be caused to move relative the terminal end 71 between a coupled condition where it is engaged with the terminal end so that rotational output of the output shaft causes the hub to rotate and a condition idle, where it is decoupled the terminal end and the hub can be idle any output of the output shaft.

The clutch member can be caused to move by an actuator 77. The actuator 77 can rotate relative the hub about the axis 75. Such rotation can cause the clutch member to be moved between the conditions idle and coupled. A cam/cam follower arrangement can translate rotational motion of the actuator to linear motion of the clutch member.

The clutch is preferably a dog clutch where the clutch member has teeth of castellations 80 that can register with teeth 81 or complementary elements to cause a torque transfer to be set up between the output shaft and the hub.

The actuator is preferably actuatable manually. It may include a handle or hand grip.

Seals 78 can ensure that the interior of the hub and the motor housing are sealed to water ingress.

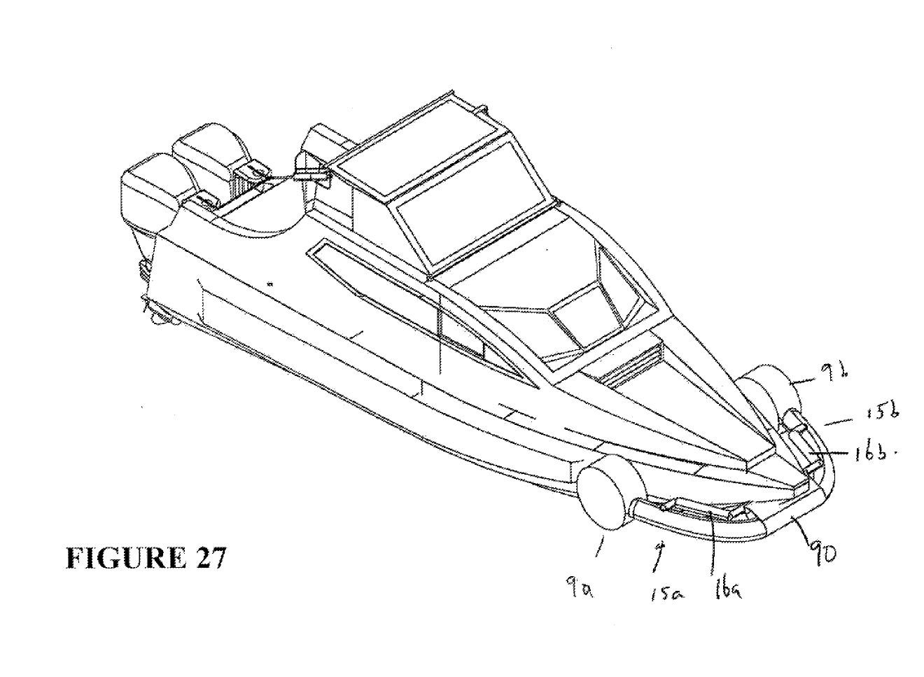

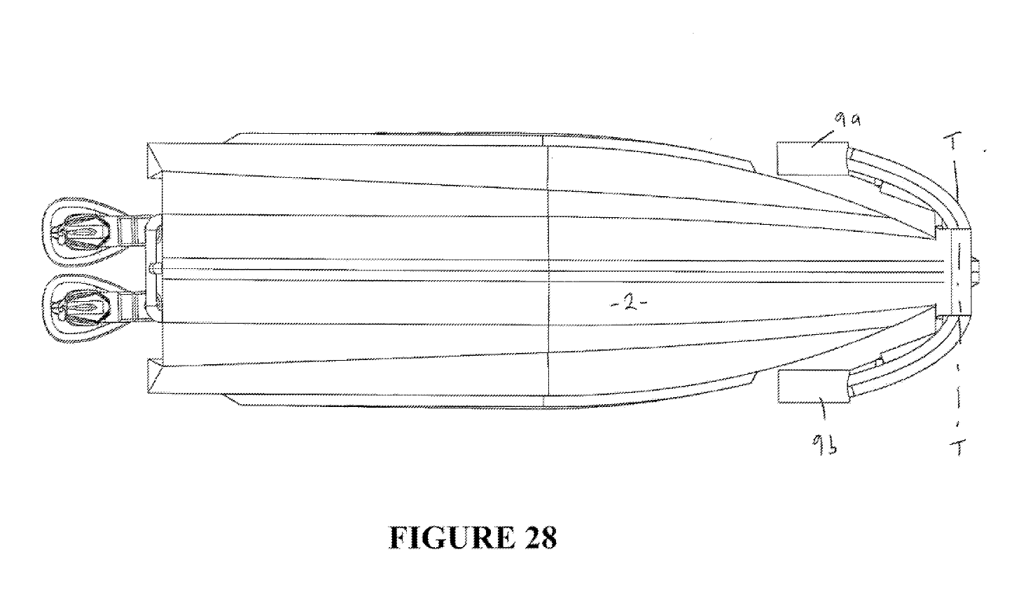

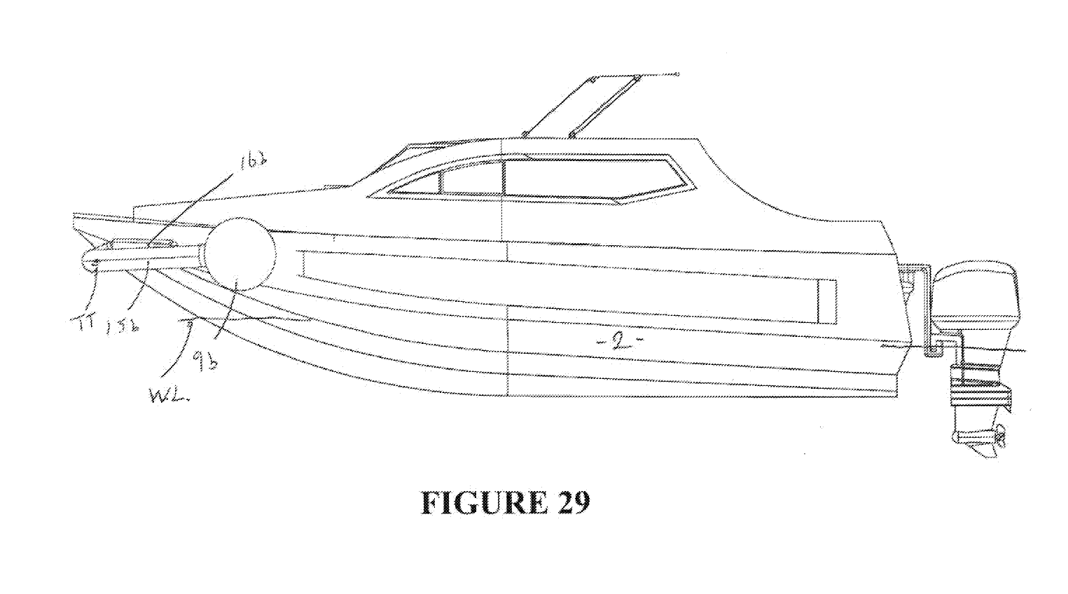

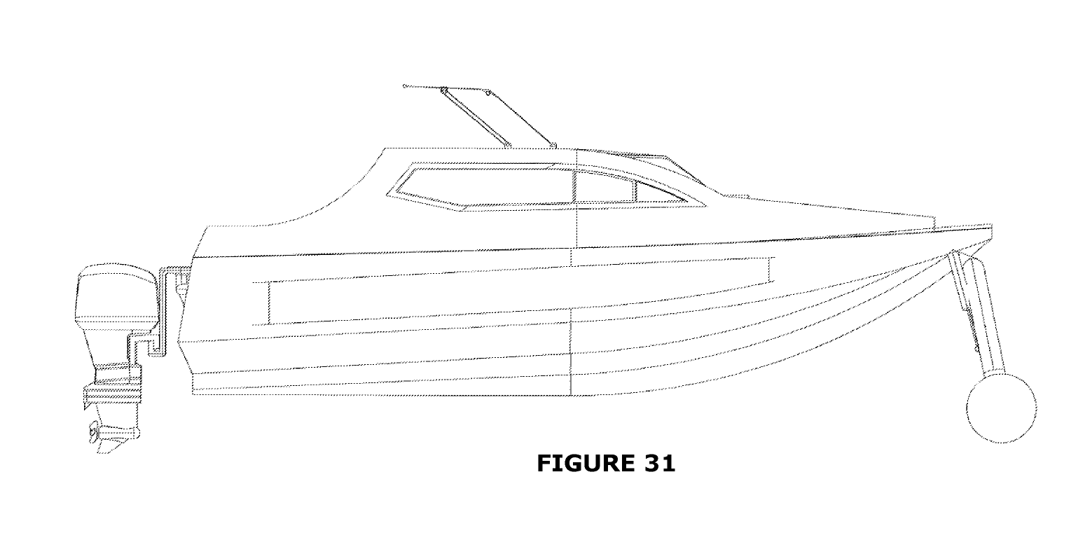

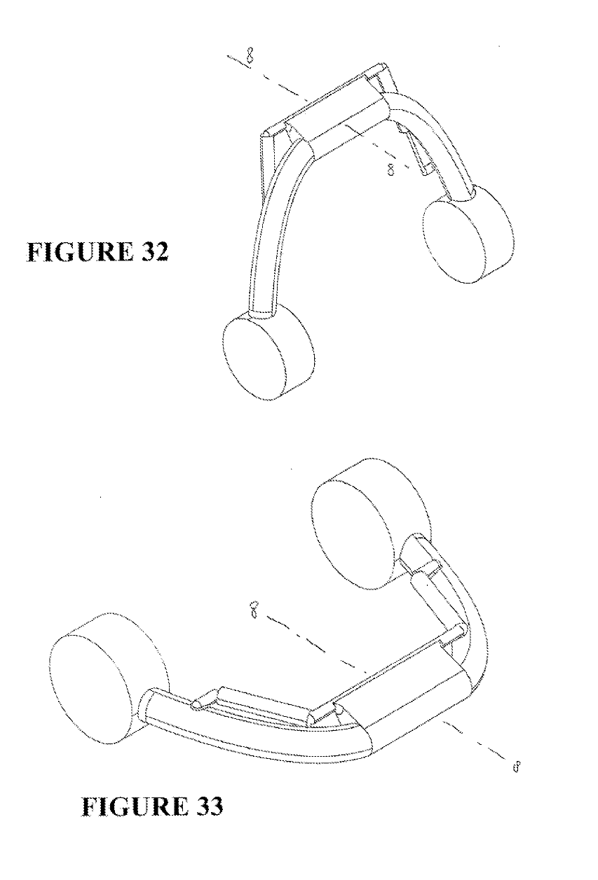

An alternative arrangement of a ground engagement assembly is shown in FIGS. 27 to 33.

There the bow assembly comprises of two strut assemblies 15 a and 15 b. These are preferably supported at the bow by a mount 90.

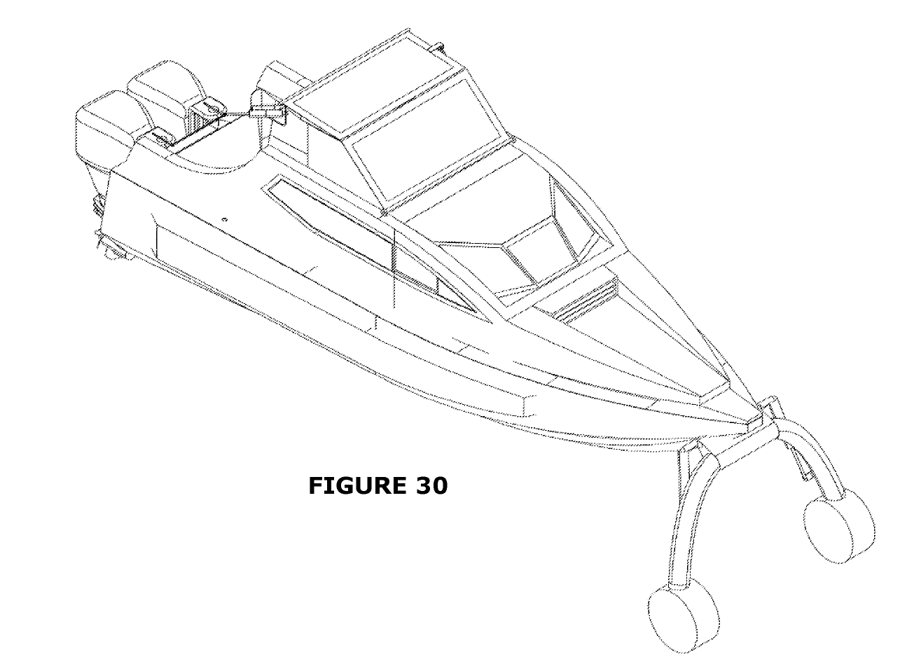

The wheel 9a, 9b supported by each strut is able to be moved between a marine mode position as shown in FIG. 27 and a land mode position as shown in FIG. 30. Actuators 16a and 16b like those of the example herein before described can move the struts. In moving from the land mode position to the marine mode position, the wheels pivot towards the stern and upwardly about axis TT. They each move to be adjacent a side of the hull on each side of the centreline 8. And above the waterline. The mount 90 is preferably mounted to position the wheels on each side of the centreline. This creates a stable platform together with two wheels at the rear (not shown) for the vessel in the land mode. The front wheels may be steerable by virtue of the use of a primary arm and steering knuckle (not shown) akin to that previously described.

Each strut 15a and 15b may move independent of the other. This can allow for the vehicle, in the land mode, to negotiate uneven terrain. Pressure sensor(s) and/or strain gauge(s) or manual control for the rotation the struts, can allow adjustment for such purposes to occur. This adjustment of the struts 15a and b as well as either or both of the stern ground engagement means can ensure that an approximately even pressure is maintained on each wheel.

1. A steerable ground engagement assembly for an amphibious surface vehicle comprising:
a strut assembly engaged or engageable to a hull of a marine vessel and comprising
a) a primary arm pivotally mounted at a proximal end relative said hull and having a distal end away from the hull,
b) a steering knuckle, carrying a ground engagement device capable of being presented by the strut assembly in (a) a marine mode position where the ground engagement device is supported above the waterline of the vessel and (b) a land mode position where the ground engagement device is able to locate on the ground to support at least part of the hull above the ground, said steering knuckle journalled from said primary arm toward its distal end to allow a rotation of the ground engagement device in a manner to control the direction of motion of the ground engagement device over the ground when in the land mode position,
c) a primary actuator operative between said hull and said primary arm, acting on the primary arm at or near its distal end to pivotally move said primary arm on an axis of rotation to thereby move the ground engagement device between the land mode position and the marine mode position.

2. An assembly as claimed in claim 1 wherein the steering knuckle is journalled to said primary arm intermediate of the proximal end of the primary arm and where the primary actuator acts on the primary arm.

3. An assembly as claimed in claim 1 wherein the steering knuckle is journalled to said primary arm only intermediate of the proximal end of the primary arm and where the primary actuator acts on the primary arm.

4. An assembly as claimed in claim 1 wherein the primary actuator is a linear actuator that extends between the distal end of the primary arm and the hull.

5. An assembly as claimed in claim 4 wherein the linear actuator is pivotally engaged to the primary arm at the distal end of the primary arm and pivotally engaged relative the hull at a location away from the axis of rotation of the primary arm.

6. An assembly as claimed in claim 1 wherein the steering knuckle has a hub at which the ground engagement device is supported, the steering knuckle presents the hub relative the primary arm so that the distal end of the primary arm is adjacent the ground engagement device.

7. An assembly as claimed in claim 1 wherein the axis of rotation of the primary arm is perpendicular a notional vertical plane passing through the centreline of the vessel.

8. An assembly as claimed in claim 4 wherein the linear actuator is pivotally mounted adjacent the axis of rotation of the primary arm to be able to rotate on an axis of rotation (hereinafter “actuator axis”) that is parallel to the axis of rotation of the primary arm.

9. An assembly as claimed in claim 8 wherein the actuator axis is further from where the primary actuator acts on said primary arm at its distal end then said axis of rotation of said primary arm.

10. An assembly as claimed in claim 8 wherein the distance between the actuator axis and the axis of rotation of the primary arm is less than the distance between the axis of rotation of the primary arm and the location at where the linear actuator acts on the primary arm at the distal end.

11. An assembly as claimed in claim 1 wherein the primary arm is bifurcated to provide a slot in which at least part of said primary actuator is located.

12. An assembly as claimed in claim 1 wherein the primary arm is recessed to provide a cavity in which at least part of said primary actuator is located.

13. An assembly as claimed in claim 4 wherein the linear actuator is a hydraulic ram that comprises a cylinder and a piston rod.

14. An assembly as claimed in claim 13 wherein one of the piston rod and cylinder is pivotally connected to the primary arm at or near its distal end.

15. An assembly as claimed in claim 14 wherein the other of the piston rod and cylinder is pivotally mounted relative the hull.

16. An assembly as claimed in claim 13 wherein the other of the piston rod and cylinder is connected with the hull at a mount that is attached to the hull.

17. An assembly as claimed in claim 16 wherein the primary arm is pivotally attached to the mount.

18. (canceled)

19. A marine vessel including the assembly of claim 1, wherein the assembly is mounted in a manner to present the primary actuator in the land mode position, more forward of the primary arm.

20-24. (canceled)

25. A steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by bearings to allow the steering knuckle to turn the wheel relative the primary arm,
3) a hydraulic ram to act between the hull and the primary arm to raise and/or lower the primary arm the steering knuckle and the wheel relative the hull, the ram acting on the primary arm at a location that is proximate more the wheel than where the bearings are located.

26. A steerable ground engagement assembly of an amphibious surface vehicle comprising:
1) a primary arm pivotally coupled to a marine hull in a manner to be capable of being raised and lowered relative to said hull,
2) a steering knuckle to rotationally support a wheel, carried by said primary arm to be raised and lowered with said primary arm and engaged to said primary arm by at least one bearing to allow the steering knuckle to turn the wheel relative the primary arm,
3) an actuator to act between the hull and the primary arm to raise and/or lower the primary arm the steering knuckle and the wheel relative the hull, the actuator acting on the primary arm at a location that is proximate more the wheel than where the at least one bearing is located.

27. (canceled)
